(19) United States
(12) Patent Application Publication
(10) Pub. No.: US 2025/0104443 A1
(43) Pub. Date: Mar. 27, 2025

(54) APPARATUS FOR RECOGNIZING OBJECT AND METHOD THEREOF

(71) Applicants: HYUNDAI MOTOR COMPANY, Seoul (KR); Kia Corporation, Seoul (KR)

(72) Inventor: Mi Rim NOH, Jeonju-si (KR)

(21) Appl. No.: 18/625,707

(22) Filed: Apr. 3, 2024

(30) Foreign Application Priority Data
Sep. 27, 2023 (KR) 10-2023-0131148

(51) Int. Cl. G06V 20/58; G01S 7/48; G06V 10/44

(52) U.S. Cl. CPC G06V 20/58; G01S 7/4802; G06V 10/44

(57) ABSTRACT

An object recognition apparatus includes a LIDAR sensor and a processor. The processor may identify whether an object is a dynamic object and identify a shape of the distribution of the contour points among a first shape, a second shape and a third shape, and assign a flag corresponding to an identified shape to the specific layer. The reference line segment may include a longer line segment among a line segment connecting a peak point and a first end point which is one of two outermost endpoints among the contour points and a line segment connecting the peak point and a second end point different from the first end point, the second end point being one of the two outermost endpoints.

### CROSS-REFERENCE TO RELATED APPLICATION

This application claims the benefit of priority to Korean Patent Application No. 10-2023-0131148, filed in the Korean Intellectual Property Office on Sep. 27, 2023, the entire contents of which are incorporated herein by reference.

### TECHNICAL FIELD

The present disclosure relates to an object recognition apparatus and method, and more particularly, to a technique for representing a shape of an object based on a contour point obtained through light detection and ranging (LIDAR).

### BACKGROUND

In autonomous vehicles, competition to develop technology to detect surrounding environments through sensors is intensifying. LIDAR has the advantage of being able to precisely detect the surrounding environments compared to radars. Accordingly, technology capable of interpreting data obtained through LIDAR is attracting attention.

A vehicle may obtain data indicating the position of an object around the vehicle through LIDAR. A distance from a LIDAR sensor to an object, for instance, may be obtained through an interval between the time when laser is transmitted by the LIDAR sensor and the time when the laser reflected by the object is received. A vehicle is able to identify the location of a point included in the object in a space where the vehicle is located, based on the angle of the transmitted laser and the distance to the object.

For precise measurements, LIDAR systems with high angular resolution has come to be used in autonomous vehicles, and the amount of data acquired through LIDAR has accordingly increased. The importance of technology for processing data obtained from LIDAR is increasing to identify the shape of objects around the vehicle from the data.

### SUMMARY

An aspect of the present disclosure provides an object recognition apparatus and method for identifying various shapes of the distribution of contour points.

An aspect of the present disclosure provides an object recognition apparatus s and method for identifying shapes corresponding to a plurality of layers.

An aspect of the present disclosure provides an object recognition apparatus and method for increasing the accuracy of object identification.

According to an aspect of the present disclosure, an object recognition apparatus includes a LIDAR sensor configured to obtain contour points of an object, and a processor.

In some implementations, the processor may identify whether the object is a dynamic object based on at least one of a reference line segment, a non-reference line segment, or a distribution of the contour points included in a specific layer among a plurality of layers representing the object, or any combination thereof, and identify a shape of the distribution of the contour points among a first shape, a second shape and a third shape, and assign a flag corresponding to an identified shape to the specific layer based on identifying at least one of that the object is a dynamic object, that a length of the reference line segment is greater than a reference length, that an angle between the reference line segment and the non-reference line segment satisfies a specified first angle range, the angle between the reference line segment and the non-reference line segment does not satisfy the specified first angle range, or the length of the reference line segment is less than or equal to the reference length, or any combination thereof. The reference line segment may include a longer line segment among a line segment connecting a peak point and a first end point which is one of two outermost endpoints among the contour points and a line segment connecting the peak point and a second end point different from the first end point, the second end point being one of the two outermost endpoints. The non-reference line segment may include a shorter line segment among the line segment connecting the first end point and the peak point and the line segment connecting the second end point and the peak point. The peak point may include a contour point located furthest from a line segment connecting the first end point and the second end point among the contour points.

In some examples, the processor may identify whether the object is a dynamic object based on at least one of a reference line segment, an unreferenced line segment, or a distribution of said contour points, or any combination thereof, based on identifying that a size of a contour box comprising contour points included in a particular layer of the plurality of layers representing the object satisfies a range of first reference sizes, identify whether a length of the reference line segment is greater than a reference length, based on identifying that the object is a dynamic object, that the length of the reference line segment is greater than the reference length, and that an angle between the reference line segment and the non-reference line segment satisfies a specified first angle range, identify that the shape of the distribution of the contour points is the first shape, assign a flag to the specific layer corresponding to the first shape, identify whether the shape of the distribution of the contour points is the second shape based on identifying that the object is a dynamic object, that the length of the reference line segment is greater than the reference length, and that an angle between the reference line segment and the non-reference line segment does not satisfy the first angle range, assign a flag corresponding to the second shape to the specific layer, when the shape of the distribution of the contour points is identified as being the second shape, identify whether the shape of the distribution of the contour points is the third shape based on identifying that the object is a dynamic object, and that the length of the reference line segment is less than or equal to the reference length, assign a flag corresponding to the third shape to the specific layer when the shape of the distribution of the contour points is identified as being the third shape, and assign a flag corresponding to the fourth shape to the specific layer when the shape of the distribution of the contour points is not identified as one of the first shape, the second shape, and the third shape. The reference line segment may include a longer line segment among a line segment connecting a peak point and a first end point which is one of two outermost endpoints among the contour points and a line segment connecting the peak point and a second end point different from the first end point, the second end point being one of the two outermost endpoints. The non-reference line segment may include a shorter line segment among the line segment connecting the first end point and the peak point and the line segment connecting the second end point and the peak point. The peak point may include a contour point located furthest from a line segment connecting the first end point and the second end point among the contour points.

In some implementations, the processor may assign a flag corresponding to a fourth shape to the specific layer when the shape of the distribution of the contour points is not identified as being one of the first shape, the second shape and the third shape. The fourth shape may indicate that the shape of the distribution of the contour points is not identified as being one of the first shape, the second shape and the third shape.

In some examples, the processor may identify whether the object is a dynamic object based on at least one of the reference line segments, the non-reference line segment, or the distribution of contour points, or any combination thereof based on identifying that a size of a contour box including the contour points satisfies a first reference size range.

In some implementations, the processor may identify whether the object is a dynamic object based on at least one of the reference line segment, the distribution of the contour points, or the length of the reference line segment, or any combination thereof based on identifying that a size of a contour box including the contour points does not satisfy first reference size range and satisfies a second reference size range, identify whether a first average value is less than a first average threshold, the first average value being an average value of at least one distance between the reference line segment and part or all of at least one contour point included in an area to which the reference line segment belongs among two areas separated by a straight line halving the angle between the reference line segment and the non-reference line segment and passing through the peak point among the contour points, identify whether a first variance value, which is a variance value for the at least one distance, is less than a first variance threshold, identify that the shape of the distribution of the contour points is the second shape based on the object being a dynamic object, the first average value being less than the first average threshold, and the first variance value being less than the first variance threshold, and assign a flag corresponding to the second shape to the specific layer, identify whether the shape of the distribution of the contour points is the third shape based on the object being a dynamic object and the first variance value being greater than or equal to the first variance threshold or the first average value being greater than or equal to the first average threshold, and when the shape of the distribution of the contour points is identified as being the third shape, assign a flag corresponding to the third shape to the specific layer, and assign the flag corresponding to the fourth shape to the specific layer when the shape of the distribution of the contour points is not identified as being one of the first shape, the second shape and the third shape.

In some examples, the processor may identify whether an object represented by the contour points is a dynamic object based on at least one of the reference line segment, the distribution of the contour points, or the length of the reference line segment, or any combination thereof based on identifying that a size of the contour box does not satisfy first reference size range and satisfies a second reference size range, identify whether a first average value is less than a first average threshold, the first average value being an average value of at least one distance between the reference line segment and part or all of at least one contour point included in an area to which the reference line segment belongs among two areas separated by a straight line halving the angle between the reference line segment and the non-reference line segment and passing through the peak point among the contour points, identify whether a first variance value, which is a variance value for the distances, is less than a first variance threshold, identify that the shape of the distribution of the contour points is the second shape based on the object being a dynamic object, the first average value being less than the first average threshold, and the first variance value being less than the first variance threshold, and assign a flag corresponding to the second shape to the specific layer, identify whether the shape of the distribution of the contour points is the third shape based on the object being a dynamic object and the first variance value being greater than or equal to the first variance threshold or the first average value being greater than or equal to the first average threshold, and when the shape of the distribution of the contour points is identified as being the third shape, assign a flag corresponding to the third shape to the specific layer, and assign the flag corresponding to the fourth shape to the specific layer when the shape of the distribution of the contour points is not identified as being one of the first shape, the second shape and the third shape.

In some implementations, the first shape may represent a shape including an L-shaped distribution identified through all or part of the contour points. The second shape may represent a shape including an I-shaped distribution identified through all or part of the contour points. The third shape may represent that the length of a long line segment of the L-shaped distribution identified through all or part of the contour points is shorter than a length of a long line segment of an L-shape corresponding to the first shape. The fourth shape may indicate that the distribution of the contour points is not identified as being one of the first shape, the second shape and the third shape.

In some examples, the processor may identify that a ratio of a length of a line segment of a cluster box identified based on the plurality of layers in one direction and a length of a line segment of a contour box including the contour points in the one direction is less than a reference ratio based on identifying that the object is a dynamic object and that the length of the reference line segment is less than or equal to the reference length, identify that the angle between the reference line segment and the non-reference line segment satisfies a second angle range, identify that the shape of the distribution of the contour points is the third shape, and assign a flag corresponding to the third shape to the specific layer based on identifying that the ratio is less than the reference ratio and that the angle between the reference line segment and the non-reference line segment satisfies the second angle range.

In some implementations, the processor may identify that a ratio of a length of a line segment of a cluster box identified based on the plurality of layers in one direction and a length of a line segment of a contour box in the one direction is less than a reference ratio based on identifying that the object is a dynamic object and that the length of the reference line segment is less than or equal to the reference length, identify that the angle between the reference line segment and the non-reference line segment satisfies a second angle range, identify that the shape of the distribution of the contour points is the third shape, and assign a flag corresponding to the third shape to the specific layer based on identifying that the ratio is less than the reference ratio and that the angle between the reference line segment and the non-reference line segment satisfies the third angle range.

In some examples, the processor may identify whether a first average value is less than or equal to a second average threshold, the first average value being an average value of at least one distance between the reference line segment and at least one contour point included in an area to which the reference line segment belongs among two areas separated by a straight line halving the angle between the reference line segment and the non-reference line segment and passing through the peak point among the contour points, based on identifying that the object is a dynamic object, that the length of the reference line segment is greater than the reference length, and that the angle between the reference line segment and the non-reference line segment does not satisfy the first angle range, identify whether the angle between the reference line segment and the non-reference line segment satisfies a third angle range, and identify that the shape of the distribution of the contour points is the second shape and assign a flag corresponding to the second shape to the specific layer based on identifying that the first average value is less than or equal to the second average threshold and that the angle between the reference line segment and the non-reference line segment satisfies the third angle range.

In some implementations, the processor may identify whether at least one contour point exists in an area between a straight line that passes through an end point included in the non-reference line segment and is perpendicular to the non-reference line segment and a straight line that passes through the peak point and is perpendicular to the non-reference line segment based on identifying that the object is a dynamic object, the first average value is greater than or equal to the first average threshold, or the first variance value is greater than or equal to the first variance threshold, identify whether the first average value is less than a third average threshold, identify whether the first variance value is less than a second variance threshold, identify whether a second average value is less than a fourth average threshold, the second average value being an average value of at least one distance between the non-reference line segment and part or all of at least one contour point included in an area to which the non-reference line segment belongs among two areas separated by a straight line halving the angle between the reference line segment and the non-reference line segment and passing through the peak point among the contour points, identify whether a second variance value is less than a third variance threshold, the second variance value being a variance for at least one distance between the non-reference line segment and at least one contour point included in an area to which an end point included in the non-reference line segment belongs, identify whether the angle between the reference line segment and the non-reference line segment satisfies a second angle range, and identify that the shape of the distribution of the contour points is the third shape and assign a flag corresponding to the third shape to the specific layer based on identifying that at least one contour point exists in the area between the straight line passing through the end point included in the non-reference line segment and perpendicular to the non-reference line segment and the straight line passing through the peak point and perpendicular to the non-reference line segment, that the first average value is less than the third average threshold, that the second average value is less than the fourth average threshold, that the first variance value is less than the second variance threshold, that the second variance value is less than the third variance threshold, and that the angle between the reference line segment and the non-reference line segment satisfies the second angle range.

In some examples, a length of a longer line segment among a line segment in a first direction and a line segment in a second direction different from the first direction among line segments of the contour box that satisfy the first reference size range may be greater than a first length value and less than a second length value that is greater than the first length value. A shorter line segment among the line segment in the first direction and the line segment in the second direction may be greater than or equal to a third length value. A length of a longer line segment among a line segment in a third direction and a line segment in a fourth direction different from the third direction among line segments of the contour box that satisfy the second reference size range may be greater than the first length value. A shorter line segment among the line segment in the third direction and the line segment in the fourth direction may be less than a fourth length value larger than the third length value.

In some implementations, the processor may identify a layer assigned the flag corresponding to the fourth shape among the plurality of layers, identify a layer assigned a flag corresponding to the first shape among the plurality of layers, identify whether a number of layers assigned the flag corresponding to the first shape among the plurality of layers is less than a number of layers assigned a flag corresponding to the second shape, and assign the flag corresponding to the second shape to the plurality of layers based on identifying that the layer assigned the flag corresponding to the fourth shape is not identified, that the layer assigned the flag corresponding to the first shape is identified, and that the number of layers assigned the flag corresponding to the first shape among the plurality of layers is less than the number of layers assigned the flag corresponding to the second shape.

In some examples, the processor may identify a layer assigned the flag corresponding to the fourth shape among the plurality of layers, identify a layer assigned a flag corresponding to the first shape among the plurality of layers, identify a layer assigned a flag corresponding to the second shape among the plurality of layers, and assign the flag corresponding to the second shape to the plurality of layers based on the layer assigned the flag corresponding to the fourth shape being not identified, the layer assigned the flag corresponding to the first shape being not identified, and the layer assigned the flag corresponding to the second shape being identified.

In some implementations, the processor may identify a layer assigned the flag corresponding to the fourth shape among the plurality of layers, identify a layer assigned a flag corresponding to the first shape among the plurality of layers, identify a layer assigned a flag corresponding to the second shape among the plurality of layers, identify a layer assigned a flag corresponding to the third shape among the plurality of layers, and assign the flag corresponding to the third shape to the plurality of layers based on the layer assigned the flag corresponding to the fourth shape being not identified, that the layer assigned the flag corresponding to the first shape being not identified, the layer assigned the flag corresponding to the second shape being not identified, and the layer assigned the flag corresponding to the third shape being identified.

According to an aspect of the present disclosure, an object recognition method includes identifying, by a processor, whether an object is a dynamic object based on at least one of a reference line segment, a non-reference line segment, a distribution of contour points included in a specific layer among a plurality of layers representing the object, or the contour points of the object being obtained through a LIDAR sensor, or any combination thereof, and identifying a shape of the distribution of the contour points among a first shape, a second shape and a third shape, and assigning a flag corresponding to an identified shape to the specific layer based on identifying, by the processor, at least one of that the object is a dynamic object, that a length of the reference line segment is greater than a reference length, that an angle between the reference line segment and the non-reference line segment satisfies a specified first angle range, the angle between the reference line segment and the non-reference line segment does not satisfy the specified first angle, or the length of the reference line segment is less than or equal to the reference length, or any combination thereof. The reference line segment may include a longer line segment among a line segment connecting a peak point and a first end point which is one of two outermost endpoints among the contour points and a line segment connecting the peak point and a second end point different from the first end point, the second end point being one of the two outermost endpoints. The non-reference line segment may include a shorter line segment among the line segment connecting the first end point and the peak point and the line segment connecting the second end point and the peak point. The peak point may include a contour point located furthest from a line segment connecting the first end point and the second end point among the contour points.

In some implementations, the object recognition method may further include identifying, by the processor, whether the object is a dynamic object according to at least one of a reference line segment, an unreferenced line segment, or a distribution of said contour points, or any combination thereof, based on identifying that a size of a contour box comprising contour points included in a particular layer of the plurality of layers representing the object satisfies a range of first reference sizes, identifying, by the processor, whether a length of the reference line segment is greater than a reference length, based on identifying that the object is a dynamic object, that the length of the reference line segment is greater than the reference length, and that an angle between the reference line segment and the non-reference line segment satisfies a specified first angle range, identify that the shape of the distribution of the contour points is the first shape, assigning, by the processor, a flag to the specific layer corresponding to the first shape, identifying, by the processor, whether the shape of the distribution of the contour points is the second shape based on identifying that the object is a dynamic object, that the length of the reference line segment is greater than the reference length, and that an angle between the reference line segment and the non-reference line segment does not satisfy the first angle range, assigning, by the processor, a flag corresponding to the second shape to the specific layer, when the shape of the distribution of the contour points is identified as being the second shape, identifying, by the processor, whether the shape of the distribution of the contour points is the third shape based on identifying that the object is a dynamic object, and that the length of the reference line segment is less than or equal to the reference length, assigning, by the processor, a flag corresponding to the third shape to the specific layer when the shape of the distribution of the contour points is identified as being the third shape, and assigning, by the processor, a flag corresponding to the fourth shape to the specific layer when the shape of the distribution of the contour points is not identified as one of the first shape, the second shape, and the third shape. The reference line segment may include a longer line segment among a line segment connecting a peak point and a first end point which is one of two outermost endpoints among the contour points and a line segment connecting the peak point and a second end point different from the first end point, the second end point being one of the two outermost endpoints. The non-reference line segment may include a shorter line segment among the line segment connecting the first end point and the peak point and the line segment connecting the second end point and the peak point. The peak point may include a contour point located furthest from a line segment connecting the first end point and the second end point among the contour points.

In some implementations, the object recognition method may further include assigning, by the processor, a flag corresponding to a fourth shape to the specific layer when the shape of the distribution of the contour points is not identified as being one of the first shape, the second shape and the third shape. The fourth shape may indicate that the shape of the distribution of the contour points is not identified as being one of the first shape, the second shape and the third shape.

In some implementations, the identifying, by the processor, whether the object is the dynamic object based on at least one of the reference line segment, the non-reference line segment, or the distribution of the contour points included in the specific layer among the plurality of layers representing the object, or any combination thereof may include identifying whether the object is a dynamic object based on at least one of the reference line segment, the non-reference line segment, or the distribution of the contour points, or any combination thereof based on identifying that a size of a contour box including the contour points satisfies a first reference size range.

In some implementations, the object recognition method may further include identifying, by the processor, whether the object is a dynamic object based on at least one of the reference line segment, the distribution of the contour points, or the length of the reference line segment, or any combination thereof based on identifying that a size of a contour box including the contour points does not satisfy first reference size range and satisfies a second reference size range, identifying, by the processor, whether a first average value is less than a first average threshold, the first average value being an average value of at least one distance between the reference line segment and part or all of at least one contour point included in an area to which the reference line segment belongs among two areas separated by a straight line halving the angle between the reference line segment and the non-reference line segment and passing through the peak point among the contour points, identifying, by the processor, whether a first variance value, which is a variance value for the at least one distance, is less than a first variance threshold, identify that the shape of the distribution of the contour points is the second shape based on the object being a dynamic object, the first average value being less than the first average threshold, and the first variance value being less than the first variance threshold, and assigning a flag corresponding to the second shape to the specific layer, identifying, by the processor, whether the shape of the distribution of the contour points is the third shape based on the object being a dynamic object and the first variance value being greater than or equal to the first variance threshold or the first average value being greater than or equal to the first average threshold, and when the shape of the distribution of the contour points is identified as being the third shape, assigning a flag corresponding to the third shape to the specific layer, and assigning, by the processor, the flag corresponding to a fourth shape to the specific layer when the shape of the distribution of the contour points is not identified as being one of the first shape, the second shape and the third shape.

In some implementations, the first shape may represent a shape including an L-shaped distribution identified through all or part of the contour points. The second shape may represent a shape including an I-shaped distribution identified through all or part of the contour points. The third shape may represent that the length of a long line segment of the L-shaped distribution identified through all or part of the contour points is shorter than a length of a long line segment of an L-shape corresponding to the first shape. The fourth shape may indicate that the shape of the distribution of the contour points is not identified as being one of the first shape, the second shape and the third shape.

In some implementations, the identifying, by the processor, whether the shape of the distribution of the contour points is the third shape based on identifying that the object is a dynamic object, and that the length of the reference line segment is less than or equal to the reference length and assigning the flag corresponding to the third shape to the specific layer when the shape of the distribution of the contour points is identified as being the third shape may include identifying, by the processor, that a ratio of a length of a line segment of a cluster box identified based on the plurality of layers in one direction and a length of a line segment of a contour box including the contour points in the one direction is less than a reference ratio based on identifying that the object is a dynamic object and that the length of the reference line segment is less than or equal to the reference length, identifying, by the processor, that the angle between the reference line segment and the non-reference line segment satisfies a second angle range, identifying, by the processor, that the shape of the distribution of the contour points is the third shape and assigning, by the processor, a flag corresponding to the third shape to the specific layer based on identifying that the ratio is less than the reference ratio and that the angle between the reference line segment and the non-reference line segment satisfies the second angle range.

In some implementations, the identifying, by the processor, whether the shape of the distribution of the contour points is the second shape based on identifying the object being the dynamic object, that the length of the reference line segment is greater than the reference length, and that the angle between the reference line segment and the non-reference line segment does not satisfy the first angle range and when the shape of the distribution of the contour points is identified as being the second shape, assigning a flag corresponding to the second shape to the specific layer may include identifying, by the processor, whether a first average value is less than or equal to a second average threshold, the first average value being an average value of at least one distance between the reference line segment and at least one contour point included in an area to which the reference line segment belongs among two areas separated by a straight line halving the angle between the reference line segment and the non-reference line segment and passing through the peak point among the contour points, identifying, by the processor, whether the angle between the reference line segment and the non-reference line segment satisfies a third angle range, and identifying, by the processor, that the shape of the distribution of the contour points is the third shape and assigning a flag corresponding to the third shape to the specific layer based on identifying that the first average value is less than or equal to the second average threshold and that the angle between the reference line segment and the non-reference line segment satisfies the third angle range.

In some implementations, the identifying, by the processor, whether the shape of the distribution of the contour points is the third shape based on identifying that the object being the dynamic object and that the length of the reference line segment is less than or equal to the reference length and when the shape of the distribution of the contour points is identified as being the third shape, assigning a flag corresponding to the third shape to the specific layer may include identifying, by the processor, whether at least one contour point exists in an area between a straight line that passes through an end point included in the non-reference line segment and is perpendicular to the non-reference line segment and a straight line that passes through the peak point and is perpendicular to the non-reference line segment based on identifying that the object is a dynamic object, the first average value is greater than or equal to the first average threshold, or the first variance value is greater than or equal to the first variance threshold, identifying, by the processor, whether the first average value is less than a third average threshold, identifying, by the processor, whether the first variance value is less than a second variance threshold, identifying, by the processor, whether a second average value is less than a fourth average threshold, the second average value being an average value of at least one distance between the non-reference line segment and part or all of at least one contour point included in an area to which the non-reference line segment belongs among two areas separated by a straight line halving the angle between the reference line segment and the non-reference line segment and passing through the peak point among the contour points, identifying, by the processor, whether a second variance value is less than a third variance threshold, the second variance value being a variance for at least one distance between the non-reference line segment and at least one contour point included in an area to which an end point included in the non-reference line segment belongs, identifying, by the processor, whether the angle between the reference line segment and the non-reference line segment satisfies a second angle range, identifying, by the processor, that the shape of the distribution of the contour points is the third shape, and assigning, by the processor, a flag corresponding to the third shape to the specific layer based on identifying that at least one contour point exists in the area between the straight line passing through the end point included in the non-reference line segment and perpendicular to the non-reference line segment and the straight line passing through the peak point and perpendicular to the non-reference line segment, that the first average value is less than the third average threshold, that the second average value is less than the fourth average threshold, that the first variance value is less than the second variance threshold, that the second variance value is less than the third variance threshold, and that the angle between the reference line segment and the non-reference line segment satisfies the second angle range.

In some implementations, a length of a longer line segment among a line segment in a first direction and a line segment in a second direction different from the first direction among line segments of the contour box that satisfy the first reference size range may be greater than a first length value and less than a second length value that is greater than the first length value. A shorter line segment among the line segment in the first direction and the line segment in the second direction may be greater than or equal to a third length value. A length of a longer line segment among a line segment in a third direction and a line segment in a fourth direction different from the third direction among line segments of the contour box that satisfy the second reference size range may be greater than the first length value. A shorter line segment among the line segment in the third direction and the line segment in the fourth direction may be less than a fourth length value larger than the third length value.

In some implementations, the object recognition method may further include identifying, by the processor, a layer assigned the flag corresponding to the fourth shape among the plurality of layers, identifying, by the processor, a layer assigned a flag corresponding to the first shape among the plurality of layers, identifying, by the processor, whether a number of layers assigned the flag corresponding to the first shape among the plurality of layers is less than a number of layers assigned a flag corresponding to the second shape, and assigning, by the processor, the flag corresponding to the second shape to the plurality of layers based on identifying that the layer assigned the flag corresponding to the fourth shape is not identified, that the layer assigned the flag corresponding to the first shape is identified, and that the number of layers assigned the flag corresponding to the first shape among the plurality of layers is less than the number of layers assigned the flag corresponding to the second shape.

In some implementations, the object recognition method may further include identifying, by the processor, a layer assigned the flag corresponding to the fourth shape among the plurality of layers, identifying, by the processor, a layer assigned a flag corresponding to the first shape among the plurality of layers, identifying, by the processor, a layer assigned a flag corresponding to the second shape among the plurality of layers, and assigning, by the processor, the flag corresponding to the second shape to the plurality of layers based on the layer assigned the flag corresponding to the fourth shape being not identified, the layer assigned the flag corresponding to the first shape being not identified, and the layer assigned the flag corresponding to the second shape being identified.

In some implementations, the object recognition method may further include identifying, by the processor, a layer assigned the flag corresponding to the fourth shape among the plurality of layers, identifying, by the processor, a layer assigned a flag corresponding to the first shape among the plurality of layers, identifying, by the processor, a layer assigned a flag corresponding to the second shape among the plurality of layers, identifying, by the processor, a layer assigned a flag corresponding to the third shape among the plurality of layers, and assigning, by the processor, the flag corresponding to the third shape to the plurality of layers based on the layer assigned the flag corresponding to the fourth shape being not identified, that the layer assigned the flag corresponding to the first shape being not identified, the layer assigned the flag corresponding to the second shape being not identified, and the layer assigned the flag corresponding to the third shape being identified.

### BRIEF DESCRIPTION OF THE DRAWINGS

FIG. 1 is a block diagram showing an example of an object recognition apparatus.

FIG. 2 shows an example of a case where a third shape is identified in an object recognition apparatus or an object recognition method.

FIG. 3 shows a flowchart of exemplary operations of an object recognition apparatus for identifying a shape representative of a plurality of layers in an object recognition apparatus or an object recognition method.

FIG. 4 shows examples of a reference line segment, a non-reference line segment, and a peak point for identifying the distribution of contour points in an object recognition apparatus or an object recognition method.

FIG. 5 shows a flowchart of exemplary operations of an object recognition apparatus for identifying whether the distribution of contour points corresponds to other shapes than the first shape when the distribution of the contour points does not correspond to the first shape in an object recognition apparatus or an object recognition method.

FIG. 6 shows a flowchart of exemplary operations of an object recognition apparatus for identifying whether the distribution of contour points corresponds to other shapes than the second shape when the distribution does not correspond to the second shape in an object recognition apparatus or an object recognition method.

FIG. 7 shows a flowchart of exemplary operations of an object recognition apparatus for assigning a flag to a layer in an object recognition apparatus or an object recognition method.

FIG. 8 shows a flowchart of exemplary operations of an object recognition apparatus for assigning a flag to a plurality of layers in an object recognition apparatus or an object recognition method.

FIG. 9 shows an example of the distribution of contour points for calculating a reliability in an object recognition apparatus or an object recognition method.

FIG. 10 shows an example of a computing system related to an object recognition apparatus or an object recognition method.

### DETAILED DESCRIPTION

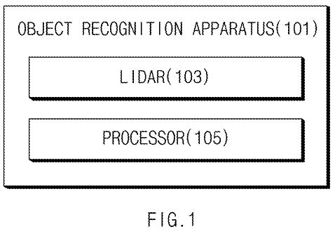

FIG. 1 is a block diagram showing an object recognition apparatus.

Referring to FIG. 1, an object recognition apparatus 101 may be implemented inside a vehicle. In this case, the object recognition apparatus 101 may be integrally formed with internal units of the vehicle, or may be implemented as a separate device and connected to the units of the vehicle by separate connection means.

Referring to FIG. 1, the object recognition apparatus 101 may include a LIDAR 103 (e.g., LIDAR sensor) and a processor 105.

In some implementations, the processor 105 may obtain location information of points of an object around a vehicle including the object recognition apparatus 101 through the LIDAR 103. The LIDAR 103 may acquire contour points included in a plurality of layers representing an object. Each contour point may indicate the position of a point on the object.

In some implementations, contour points may be obtained by the LIDAR 103. For example, the contour points may be identified in each of layers formed based on a z-axis, among a x-axis, a y-axis, and the z-axis.

For example, the contour points may be obtained based on representative points included in a point cloud in each of the layers formed on the z-axis among the x-axis, the y-axis, and the z-axis. For example, the representative points may include all or part of points located outside among a plurality of points included in the point cloud. For example, a point cloud may be obtained by performing clustering based on each of a plurality of points acquired by the LIDAR 103 being identified within a specified distance.

In some implementations, the processor of the object recognition apparatus may acquire contour points representing an object and existing on a plane parallel to a specific plane, through a layer. For example, the specific plane may include a plane parallel to the ground surface. For example, the specific plane may include a plane perpendicular to the ground surface and including the moving direction of a vehicle.

In some implementations, the processor 105 of the object recognition apparatus 101 may determine a shape representative of the shape of an object based on flags assigned to a plurality of layers. The processor 105 may assign a flag to each of layers included in the plurality of layers according to the distribution of contour points included in each layer.

For example, all or part of contour points included in a specific layer corresponding to a first shape (e.g., L-shape) may represent an L-shaped distribution. For example, all or part of contour points included in a specific layer corresponding to a second shape (e.g., I-shape) may represent an I-shaped distribution. For example, all or part of the contour points corresponding to a third shape (e.g., sL-shape) and included in a specific layer may represent an L-shaped distribution whose a long line segment is shorter than the length of the long line segment of an L-shaped distribution corresponding to the first shape. For example, a fourth shape (e.g., break-shape) may indicate that the distribution of contour points representing an object and included in a specific layer is not identified as one of the first shape, the second shape, and the third shape. A flag corresponding to the fourth shape may be referred to as a break flag.

For example, the contour points included in a specific layer corresponding to one of the first shape, the second shape, and the third shape include contour points corresponding to a first line segment, and contour points corresponding to a second line segment. The second line segment may connect to the end point of the first line segment. In a specific layer corresponding to the first shape, an angle between the first line segment and the second line segment may fall within a specified angle range. The length of the first line segment may be greater than a specified length. In a specific layer corresponding to the second shape, an angle between the first line segment and the second line segment may be outside the specified angle range. In a specific layer corresponding to the third shape, the length of the first line segment may be less than or equal to the specified length.

For example, the distribution of contour points of the first shape may be represented by the sides and back of an object, such as a vehicle. The distribution of contour points of the second shape may be represented by either the side or the back of the object, which is a vehicle. The distribution of contour points of the third shape may appear in a portion of one of the side or rear of an object being a vehicle or appear based on an object being a vehicle tilted with respect to the vehicle including the object recognition apparatus 101.

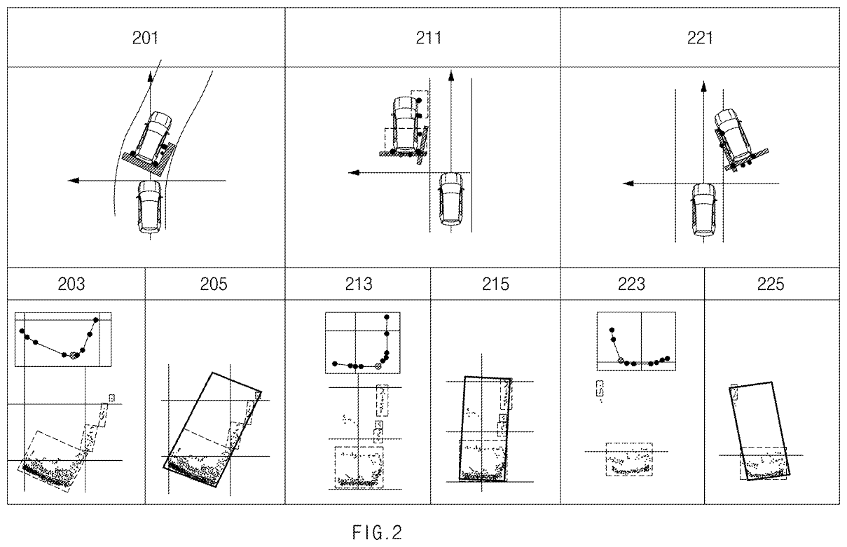

FIG. 2 shows an example of a case where a third shape is identified in an object recognition apparatus or an object recognition method In some implementations of the present disclosure.

Referring to FIG. 2, a third shape may be identified in a first situation 201, a second situation 211, and a third situation 221. In a first phase 203 of the first situation 201, a first phase 213 of the second situation 211, and/or a first phase 223 of the third situation 221, the processor of the object recognition apparatus may identify an area including part of contour points included in a specific layer and an area including the other part of the contour points included in the specific layer based on the distribution of the identified contour points. In a second phase 205 of the first situation 201, a second phase 215 of the second situation 211, and/or a second phase 225 of the third situation 221, the area of an object corresponding to contour points may be identified by connecting an area including part of the contour points and an area including the other part of the contour points.

In some implementations, in the first situation 201, the object recognition apparatus may identify a preceding vehicle turning along a curved road in front of a vehicle including the object recognition apparatus as an object. The processor of the object recognition apparatus may acquire contour points representing the object that is the preceding vehicle in the first situation 201 and included in a specific layer.

In the second situation 211, the object recognition apparatus may identify a vehicle traveling in the front or lateral direction of the vehicle including the object recognition apparatus as an object. The processor of the object recognition apparatus may acquire contour points representing the object that is the preceding vehicle in the second situation 211 and included in a specific layer.

In the third situation 221, the object recognition apparatus may identify a vehicle that cuts in from the front or side in the moving direction of the vehicle including the object recognition apparatus as an object. The processor of the object recognition apparatus may acquire contour points representing an object that is the vehicle cutting in in the third situation 221.

In the first situation 201, the second situation 211, or the third situation 221, the processor of the object recognition apparatus may identify the shape of the distribution of part of the contour points (e.g., the first shape, the second shape, the third shape, the fourth shape) based on the distribution of the contour points. The processor of the object recognition apparatus may identify an area including the part of the contour points based on the shape of the part of the contour points. According to the angle at which the object is inclined with respect to the vehicle or the direction in which the object travels, contour points representing the object and included in a specific layer may be separated into different areas.

For example, in the first phase 203 of the first situation 201, the first phase 213 of the second situation 211, and/or the first phase 223 of the third situation 221, the processor of the object recognition apparatus may identify the area of part of the contour points representing the object and the area of the other part of the contour points representing the object. The area identified based on the part of contour points representing the object and the area identified based on the other part of contour points representing the object may be separated.

In the second phase 205 of the first situation 201, the second phase 215 of the second situation 211, and/or the second phase 225 of the third situation 221, the processor of the object recognition apparatus may identify an area corresponding to the object by connecting the area of the part of the contour points that represent the object and are included in the specific layer to the area of the other part of the contour points that represent the object and are included in the specific layer.

Connecting the plurality of areas when there is an area including contour points distributed in the third shape among the plurality of areas may be easier than connecting the plurality of areas when there is no area including contour points distributed in the third shape among the plurality of areas. Further, the likelihood that the object represented by the contour points in the plurality of areas is a dynamic object when there is an area including contour points distributed in the fourth shape may be greater than the object represented by the contour points in the plurality of areas is a dynamic object when there is no area including contour points identified as the fourth shape.

In some implementations, the processor of the object recognition apparatus may identify whether the distribution of contour points included in the specific layer corresponds to the third shape before a flag corresponding to the fourth shape is assigned to the contour points although the distribution of contour points included in the specific layer is not identified as one of the first shape and the second shape.

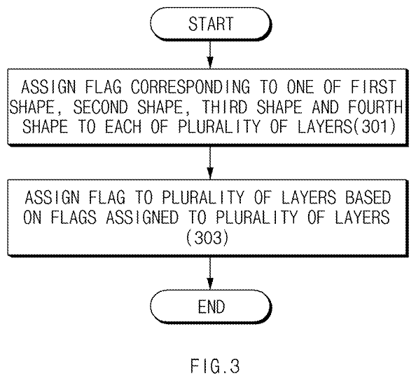

FIG. 3 shows a flowchart of operations of an object recognition apparatus for identifying a shape representative of a plurality of layers in an object recognition apparatus or an object recognition method In some implementations of the present disclosure.

Hereinafter, it is assumed that the object recognition apparatus 101 of FIG. 1 performs the process of FIG. 3. Additionally, in the description of FIG. 3, operations described as being performed by the object recognition apparatus 101 or operations described as being performed by the processor 105 may be understood as being controlled by the processor 105 of the object recognition apparatus 101.

Referring to FIG. 3, in a first operation 301, in some implementations, the processor of the object recognition apparatus may assign a flag corresponding to one of a first shape, a second shape, a third shape, and a fourth shape to each of a plurality of layers.

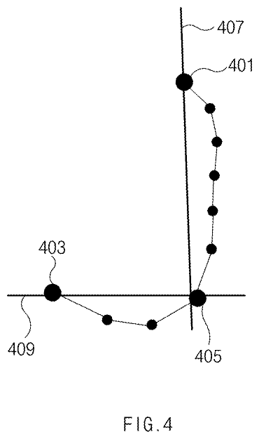

In some implementations, the processor of the object recognition apparatus may identify the distribution of contour points included in a specific layer among the plurality of layers as one of the first shape, the second shape, the third shape, and the fourth shape. The processor of the object recognition apparatus may assign a flag corresponding to the identified shape to a layer including the contour points, based on the shape of the distribution of the contour points included in the specific layer. Hereinafter, a method of assigning a flag to each layer will be described with reference to FIGS. 4, 5, 6, and/or 7.

In a second operation 303, in some implementations, the processor of the object recognition apparatus may assign flags to a plurality of layers based on flags assigned to the plurality of layers. The flags assigned to the plurality of layers may correspond to shapes representative of the plurality of layers.

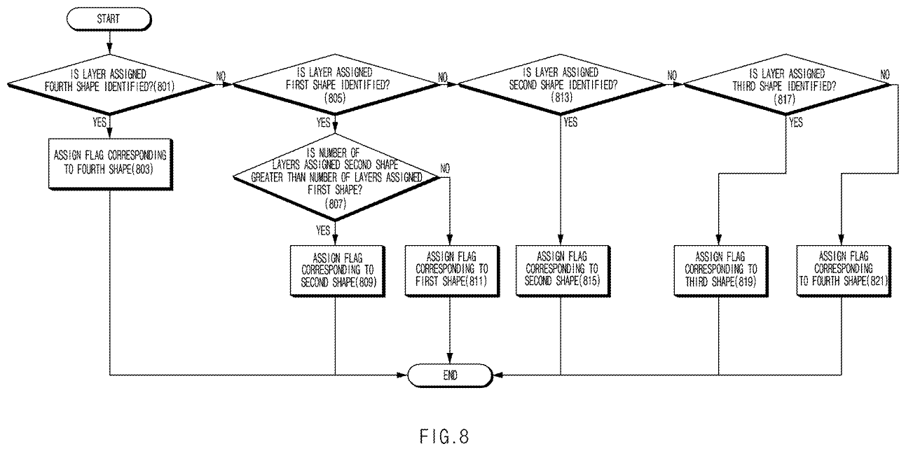

In some implementations, the processor of the object recognition apparatus may determine the shape of an object using flags assigned to a plurality of layers. The shape of the object may be one of the first shape, the second shape, the third shape, and the fourth shape. The processor of the object recognition apparatus may assign a flag to a plurality of layers representing an object according to the shape of the object. Because there may be multiple layers including contour points representing the object, identifying one shape representative of the object and assigning one flag to the plurality of layers according to the flags assigned to the plurality of layers may be important for object recognition and association. Hereinafter, a method of assigning one flag to a plurality of layers according to the flags assigned to the plurality of layers will be described with reference to FIG. 8.

FIG. 4 shows examples of a reference line segment, a non-reference line segment, and a peak point for identifying the distribution of contour points in an object recognition apparatus or an object recognition method In some implementations of the present disclosure.

Referring to FIG. 4, a first end point 401 and a second end point 403 may correspond to the outermost contour points. A peak point 405 may include a contour point located furthest from a line segment connecting the first end point 401 and the second end point 403. A first line segment 407 may include a line segment connecting the first end point 401 and the peak point 405. A second line segment 409 may include a line segment connecting the second end point 403 and the peak point 405. A reference line segment may include a longer line segment among the first line segment 407 and the second line segment 409. A non-reference line segment may include a c among the first line segment 407 and the second line segment 409.

In some implementations, the processor of the object recognition apparatus may acquire points representing the object through LIDAR. The processor of the object recognition apparatus may acquire contour points including part or all of points located outside among the points representing the object. The processor of the object recognition apparatus may identify whether the distribution of the contour points corresponds to one of the first shape, the second shape, the third shape, and the fourth shape.

In some implementations, to identify the distribution of the contour points, the processor of the object recognition apparatus may consider elements such as the size of a contour box, whether the object is a dynamic object, the length of the reference line segment, an angle between the reference line segment and the non-reference line segment, an average distance and a variance value for the reference line segment, an average distance and a variance value for the non-reference line segment, and whether contour points exist in a specific area.

In some implementations, the contour box may be generated (or formed) based on contour points. For example, the contour box may correspond to an external object. For example, the contour box may include the virtual box to which the information related to the external object is assigned. For example, the information related to the external object may include at least one of the types of the external object, the speed of the external object, the moving direction of the external object, or the position of the external object, or any combination thereof. The contour box may represent an area of a range including part or all of contour points included in a specific layer.

In some implementations, the processor of the object recognition apparatus may identify whether an object is a dynamic object based on identifying that the size of a contour box including contour points included in a specific layer among the plurality of layers representing the object satisfies a first reference size range.

In some implementations, when the size of the contour box satisfies the first reference size range, the processor of the object recognition apparatus may identify that the object is a dynamic object based on identifying that at least one contour point exists in an area between a straight line passing through an end point included in the reference line segment and perpendicular to the reference line segment and a straight line passing through the peak point 405 and perpendicular to the reference line segment, that at least one contour point exists in an area between a straight line passing through an end point included in the non-reference line segment and perpendicular to the non-reference line segment and a straight line passing through the peak point 405 and perpendicular to the non-reference line segment, that a first average value is less than a third average threshold, that a first variance value is less than a second variance threshold, that a second average value is less than a fourth average threshold, or that a second variance value is less than a third variance threshold.

For example, when the size of the contour box satisfies the first reference size range, the processor of the object recognition apparatus may identify whether at least one contour point exists in the area between the straight line passing through the end point (e.g., the first end point 401 or the second end point 403) included in the reference line segment (e.g., the first line segment 407 or the second line segment 409) and perpendicular to the reference line segment and the straight line passing through the peak point 405 and perpendicular to the reference line segment to identify whether the object is a dynamic object. For example, to identify whether the object is a dynamic object, the processor of the object recognition apparatus may identify that at least one contour point exists in the area between the straight line passing through the end point included in the non-reference line segment and perpendicular to the non-reference line segment and the straight line passing through the peak point 405 and perpendicular to the non-reference line segment.

For example, when the size of the contour box satisfies the first reference size range, to identify whether the object is a dynamic object, the processor of the object recognition apparatus may identify whether a first average value is less than a third average threshold (e.g., about 0.15), the first average value being an average value of at least one distance between the reference line segment and part or all of at least one contour point included in an area to which the reference line segment belongs among two areas separated by a straight line halving an angle between the reference line segment and the non-reference line segment and passing through the peak point 405. The processor of the object recognition apparatus may identify whether a first variance value, which is a variance value for at least one distance between the reference line segment and part or all of at least one contour point included in the area to which the reference line segment belongs, is less than a second variance threshold (e.g., about 0.55).

For example, when the size of the contour box satisfies the first reference size range, to identify whether the object is a dynamic object, the processor of the object recognition apparatus may identify whether a second average value is less than a fourth average threshold (e.g., about 0.5), the second average value being an average value of at least one distance between the non-reference line segment and part or all of at least one contour point included in an area to which the reference line segment belongs among two areas separated by a straight line halving an angle between the reference line segment and the non-reference line segment and passing through the peak point 405. The processor of the object recognition apparatus may identify whether a second variance value, which is a variance value for at least one distance between the non-reference line segment and part or all of at least one contour point included in the area to which the non-reference line segment belongs, is less than the third variance threshold (e.g., about 3.0).

In some implementations, the processor of the object recognition apparatus may identify the shape of the distribution of contour points included in a specific layer as being the first shape based on identifying that the size of the contour box satisfies the first reference size range, that the object is a dynamic object, that the length of the reference line segment is greater than the reference length, or that the angle between the reference line segment and the non-reference line segment satisfies a specified first angle range.

An existing object recognition apparatus may identify the shape of the distribution of contour points included in the specific layer as being the fourth shape when the length of the reference line segment is less than or equal to the reference length, or the angle between the reference line segment and the non-reference line segment does not satisfy the specified first angle range although the size of the contour box satisfies the first reference size range and the object is a dynamic object.

In some implementations, the processor of the object recognition apparatus may identify whether the shape of the distribution of contour points included in the specific layer is the third shape rather than immediately identifying the shape of the distribution of contour points as being the fourth shape when the size of the contour box satisfies the first reference size range and the object is a dynamic object although the length of the reference line segment is less than or equal to the reference length.

In some implementations, the processor of the object recognition apparatus may identify whether the shape of the distribution of contour points included in the specific layer is the second shape rather than immediately identifying the shape of the distribution of contour points as being the fourth shape, when the size of the contour box satisfies the first reference size range, the object is a dynamic object, and the length of the reference line segment is greater than the reference length although the angle between the reference line segment and the non-reference line segment does not satisfy the specified first angle range.

In some implementations, the processor of the object recognition apparatus may identify whether an object is a dynamic object based on identifying that the size of a contour box representing the object satisfies a second reference size range.

For example, when the size of the contour box satisfies the second reference size range, the processor of the object recognition apparatus may identify that at least one contour point exists in the area between the straight line passing through the end point included in the reference line segment and perpendicular to the reference line segment and the straight line passing through the peak point 405 and perpendicular to the reference line segment, to identify whether the object is a dynamic object.

It should be noted that, when the size of the contour box satisfies the second reference size range, the distribution of contour points is likely to correspond to the second shape, and therefore the distribution for the non-reference line segment may not be identified.

For example, when the size of the contour box satisfies the second reference size range, the processor of the object recognition apparatus may identify whether the length of the reference line segment is greater than a specified length (e.g., about 4.5 m) to identify whether the object is a dynamic object.

For example, when the size of the contour box satisfies the second reference size range, the processor of the object recognition apparatus may identify whether the first average value is less than a first average threshold (e.g., about 0.05) to identify whether the object is a dynamic object. The processor of the object recognition apparatus may identify whether the first variance value is less than a first variance threshold (e.g., about 0.2).

In some implementations, the processor of the object recognition apparatus may identify the shape of the distribution of contour points included in a specific layer as being the second shape based on identifying that the size of the contour box satisfies the second reference size range, that the object is a dynamic object, that the first average value is less than the first average threshold, or that the first variance value is less than the first variance threshold.

An existing object recognition apparatus may identify the shape of the distribution of contour points included in the specific layer as being the fourth shape when the first average value is greater than or equal to the first average threshold, or the first variance value is greater than or equal to the first variance threshold although the size of the contour box satisfies the second reference size range and the object is a dynamic object.

In some implementations, the processor of the object recognition apparatus may identify whether the shape of the distribution of contour points included in the specific layer is the third shape rather than immediately identifying the shape of the distribution of contour points as being the fourth shape when the object is a dynamic object although the first average value is greater than or equal to the first average threshold, or the first variance value is greater than or equal to the first variance threshold.

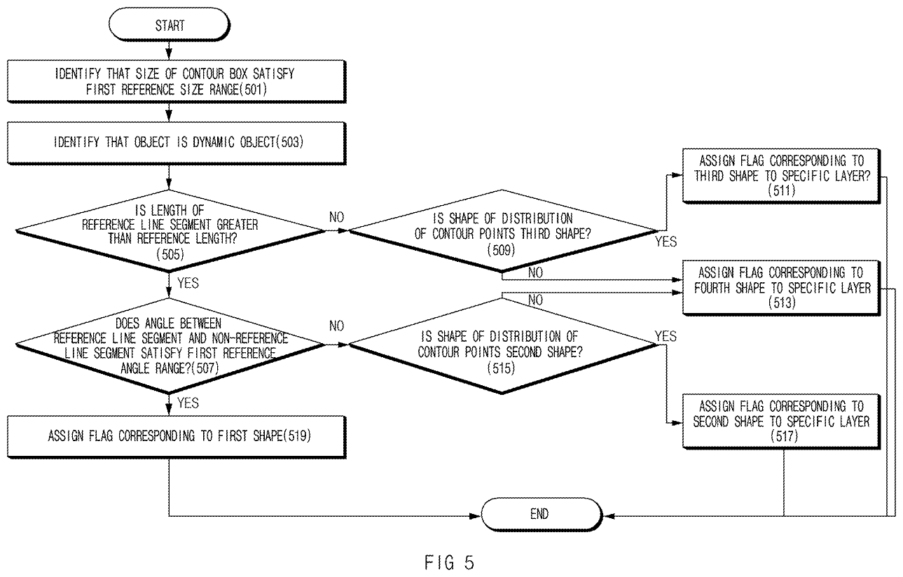

FIG. 5 shows a flowchart of operation of an object recognition apparatus for identifying whether the distribution of contour points corresponds to other shapes than the first shape when the distribution of the contour points does not correspond to the first shape in an object recognition apparatus or an object recognition method In some implementations of the present disclosure.

Hereinafter, it is assumed that the object recognition apparatus 101 of FIG. 1; performs the process of FIG. 5. Additionally, in the description of FIG. 5, operations described as being performed by the object recognition apparatus 101 or operations described as being performed by the processor 105 may be understood as being controlled by the processor 105 of the object recognition apparatus 101.

Referring to FIG. 5, in a first operation 501, in some implementations, the processor of the object recognition apparatus may identify that the size of the contour box satisfies a first reference size range. This is because the shape may be roughly determined based on the size of the contour box. The probability that the object represented by the contour points included in the contour box that satisfies the first reference size range has the first shape may be greater than the probability that the object represented by the contour points included in the contour box has the second shape.

For example, the length of a longer line segment between a line segment in a first direction of the contour box that satisfies the first reference size range and a line segment in a second direction different from the first direction may be greater than a first length value (e.g., about 1 m) and smaller than a second length value (e.g., about 8 m) that is greater than the first length value. The length of a shorter line segment between the line segment in the first direction and the line segment in the second direction may be greater than or equal to a third length value (e.g., about 0.8 m). The contour box may represent an area of a range including part or all of contour points included in a specific layer.

In a second operation 503, in some implementations, the processor of the object recognition apparatus may identify that the object is a dynamic object.

In some implementations, the processor of the object recognition apparatus may identify that the object is a dynamic object based on identifying that at least one contour point exists in an area between a straight line passing through an end point included in the reference line segment and perpendicular to the reference line segment and a straight line passing through the peak point and perpendicular to the reference line segment, that at least one contour point exists in an area between a straight line passing through an end point included in the non-reference line segment and perpendicular to the non-reference line segment and a straight line passing through the peak point and perpendicular to the non-reference line segment, that a first average value is less than a third average threshold, that a first variance value is less than a second variance threshold, that a second average value is less than a fourth average threshold, or that the second variance value is less than a third variance threshold. Because the operation of the object recognition apparatus for identifying whether an object is a dynamic object has been described with reference to FIG. 4, a redundant description will be omitted below.

In a third operation 505, in some implementations, the processor of the object recognition apparatus may identify whether the length of the reference line segment is greater than a reference length (e.g., about 2 m). When the length of the reference line segment is greater than the reference length, the processor of the object recognition apparatus may perform a fourth operation 507. When the length of the reference line segment is less than or equal to than the reference length, the processor of the object recognition apparatus may perform a fifth operation 509. This is because, when the length of the reference line segment is not greater than the reference length, it is difficult to identify the shape of the contour points as being the first shape.

In the fifth operation 509, in some implementations, the processor of the object recognition apparatus may identify whether the shape of the distribution of contour points is the third shape. When the shape of the distribution of contour points is the third shape, the processor of the object recognition apparatus may perform a sixth operation 511. When the shape of the distribution of contour points is not the third shape, the processor of the object recognition apparatus may perform a seventh operation 513.

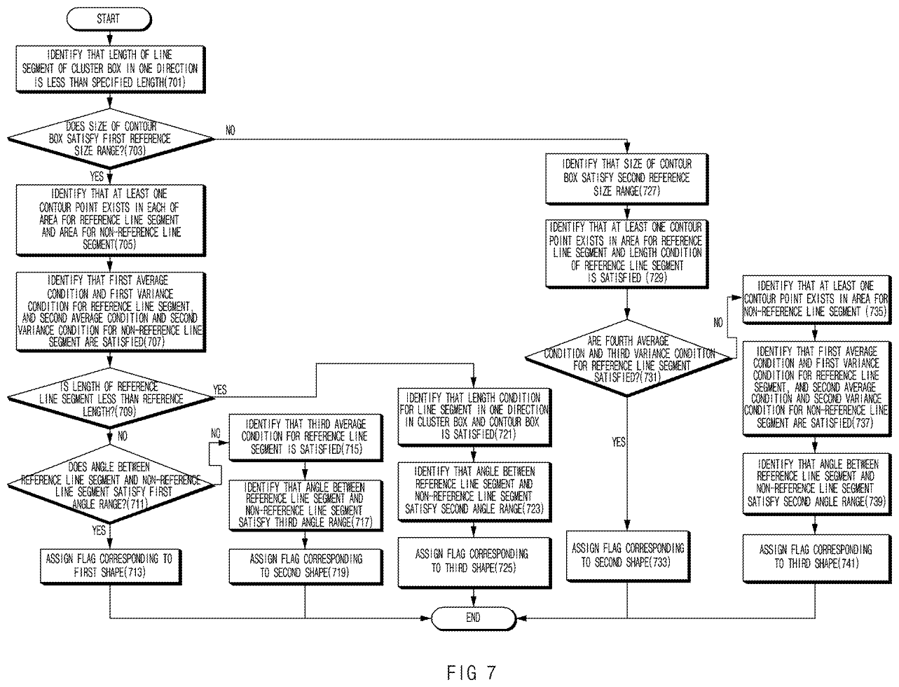

In some implementations, unlike the existing object recognition apparatus, when the length of the reference line segment is less than or equal to the reference length, the processor of the object recognition apparatus may rather determine whether the shape of the distribution is identified as being the third shape than immediately identify the shape of the distribution as being the fourth shape. To identify whether the shape of the distribution of contour points of the specific layer is the third shape, the processor of the object recognition apparatus may perform an eighth operation 721 and a ninth operation 723 of FIG. 7 below.

In the sixth operation 511, in some implementations, the processor of the object recognition apparatus may assign a flag corresponding to the third shape to the specific layer. The processor of the object recognition apparatus may indicate that the shape of the distribution of contour points is identified as being the third shape, through the flag.

In the seventh operation 513, in some implementations, the processor of the object recognition apparatus may assign a flag corresponding to the fourth shape to the specific layer. The processor of the object recognition apparatus may indicate that the shape of the distribution of contour points is identified as being the fourth shape, through the flag.

In the fourth operation 507, in some implementations, the processor of the object recognition apparatus may identify whether an angle between the reference line segment and the non-reference line segment satisfies a first angle range. When the angle between the reference line segment and the non-reference line segment satisfies the first angle range, the processor of the object recognition apparatus may perform an eighth operation 519. When the angle between the reference line segment and the non-reference line segment does not satisfy the first angle range, the processor of the object recognition apparatus may perform a ninth operation 515. This is because the shape of the distribution of contour points is identified as being the L-shape that is the first shape when the angle of the reference line segment and the non-reference line segment satisfies the first angle range (e.g., greater than about 80°, less than about) 120°.

In the eighth operation 519, in some implementations, the processor of the object recognition apparatus may assign a flag corresponding to the first shape. The processor of the object recognition apparatus may indicate that the shape of the distribution of contour points is identified as being the first shape, through the flag.

In the ninth operation 515, in some implementations, the processor of the object recognition apparatus may identify whether the shape of the distribution of contour points is the second shape. When the shape of the distribution of contour points is the second shape, the processor of the object recognition apparatus may perform a tenth operation 517. When the shape of the distribution of contour points is not the second shape, the processor of the object recognition apparatus may perform the seventh operation 513.

In some implementations, unlike the existing object recognition apparatus, although the angle between the reference line segment and the non-reference line segment does not satisfy the first angle range, the processor of the object recognition apparatus may determine whether the shape of the distribution is identified as being the second shape rather than immediately identifying the shape of the distribution as being the fourth shape. To identify whether the shape of the distribution of contour points of the specific layer is the second shape, the processor of the object recognition apparatus may perform a twelfth operation 715 and a thirteenth operation 717 of FIG. 7 below.

In the tenth operation 517, in some implementations, the processor of the object recognition apparatus may assign a flag corresponding to the second shape to the specific layer. The processor of the object recognition apparatus may indicate that the shape of the distribution of contour points is identified as being the second shape, through the flag.

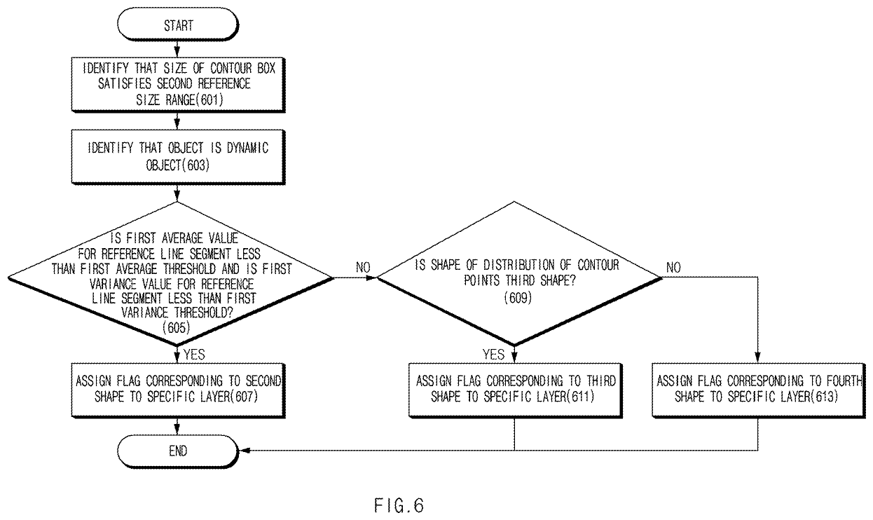

FIG. 6 shows a flowchart of operation of an object recognition apparatus for identifying whether the distribution of contour points corresponds to other shapes than the second shape when the distribution does not correspond to the second shape in an object recognition apparatus or an object recognition method In some implementations of the present disclosure.

Hereinafter, it is assumed that the object recognition apparatus 101 of FIG. 1 performs the process of FIG. 6. Additionally, in the description of FIG. 6, operations described as being performed by the object recognition apparatus 101 or operations described as being performed by the processor 105 may be understood as being controlled by the processor 105 of the object recognition apparatus 101.

Referring to FIG. 6, in a first operation 601, in some implementations, the processor of the object recognition apparatus may identify that the size of a contour box satisfies a second reference size range. Among the line segments of the contour box satisfying the second reference size range, the length of a longer line segment among a line segment in a third direction and a line segment in a fourth direction different from the third direction may be greater than a first length value (e.g., about 1 m). The length of a shorter line segment among the line segment in the third direction and the line segment in the fourth direction may be smaller than a fourth length value (e.g., about 1 m). The fourth length value (e.g., about 1 m) in the second reference size range may be greater than the third length value (e.g., about 0.8 m) in the first reference size range.

In some implementations, when the size of the contour box satisfies the first reference size range and also satisfies the second reference size range, the processor of the object recognition apparatus may identify the shape of the distribution of contour points for the specific layer by performing the operations of FIG. 5.

In a second operation 603, in some implementations, the processor of the object recognition apparatus may identify that the object is a dynamic object. When the size of the contour box satisfies the second reference size range, the processor of the object recognition apparatus may identify that the object is a dynamic object based on identifying that at least one contour point exists in an area between a straight line passing through an end point included in the reference line segment and perpendicular to the reference line segment and a straight line passing through the peak point and perpendicular to the reference line segment or that the length of the reference line segment is greater than a specified length. Because the operation of the object recognition apparatus for identifying whether an object is a dynamic object has been described with reference to FIG. 4, a redundant description will be omitted below.

In a third operation 605, in some implementations, the processor of the object recognition apparatus may identify whether a first average value for the reference line segment is less than a first average threshold and a first variance value for the reference line segment is less than a first variance threshold. When the first average value for the reference line segment is less than the first average threshold and the first variance value for the reference line segment is less than the first variance threshold, the processor of the object recognition apparatus may perform a fourth operation 607. When the first average value for the reference line segment is greater than or equal to the first average threshold or the first variance value for the reference line segment is greater than or equal to the first variance threshold, the processor of the object recognition apparatus may perform a fifth operation 609. In some implementations, the processor of the object recognition apparatus may identify how closely contour points are distributed to the reference line segment based on the first average value and the first variance value.

In the fourth operation 607, in some implementations, the processor of the object recognition apparatus may assign a flag corresponding to the second shape to the specific layer. The processor of an object recognition apparatus may not consider the shape of the distribution of points corresponding to the non-reference line segment when identifying whether the shape of the distribution of contour points in a specific layer is the second shape.

In the fifth operation 609, in some implementations, the processor of the object recognition apparatus may identify whether the shape of the distribution of contour points is the third shape. When the shape of the distribution of contour points is the third shape, the processor of the object recognition apparatus may perform a sixth operation 611. When the shape of the distribution of contour points is not the third shape, the processor of the object recognition apparatus may perform a seventh operation 613.

In some implementations, unlike the existing object recognition apparatus, when the first average value is greater than or equal to the first average threshold or the first variance value is greater than or equal to the first variance threshold, the processor of the object recognition apparatus may determine whether the shape of the distribution is identified as being the third shape rather than immediately identifying the shape of the distribution as being the fourth shape. To identify whether the shape of the distribution of contour points of the specific layer is the third shape, the processor of the object recognition apparatus may perform an eighteenth operation 735, a nineteenth operation 737, and a twentieth operation 739 of FIG. 7 below.

In the sixth operation 611, in some implementations, the processor of the object recognition apparatus may assign a flag corresponding to the third shape to the specific layer. The processor of the object recognition apparatus may indicate that the shape of the distribution of contour points included in a specific layer is identified as being the third shape, through the flag.

In the seventh operation 613, in some implementations, the processor of the object recognition apparatus may assign a flag corresponding to the fourth shape to the specific layer. The processor of the object recognition apparatus may indicate that the shape of the distribution of contour points included in the specific layer is identified as being the fourth shape, through the flag.

FIG. 7 shows a flowchart of operation of an object recognition apparatus for assigning a flag to a layer in an object recognition apparatus or an object recognition method In some implementations of the present disclosure.

Hereinafter, it is assumed that the object recognition apparatus 101 of FIG. 1 performs the process of FIG. 7.

Additionally, in the description of FIG. 7, operations described as being performed by the object recognition apparatus 101 or operations described as being performed by the processor 105 may be understood as being controlled by the processor 105 of the object recognition apparatus 101.

Referring to FIG. 7, in a first operation 701, the processor of an object apparatus recognition In some implementations may identify that the length of a line segment in one direction of a cluster box is less than a specified length (e.g., about 13 m). The cluster box may include part or all of contour points included in a plurality of layers. Because the object is likely to be a stationary object when the cluster box is greater than the specified length, there may be little need to identify shapes of the distribution of contour points in various manners.

In a second operation 703, in some implementations, the processor of the object recognition apparatus may identify whether the size of the contour box satisfies a first reference size range. When the size of the contour box satisfies the first reference size range, the processor of the object recognition apparatus may perform a third operation 705. When the size of the contour box does not satisfy the first reference size range, the processor of the object recognition apparatus may perform a fourth operation 727. This is because the shape may be roughly determined based on the size of the contour box. The probability that the object represented by the contour points included in the contour box that satisfies the first reference size range has the first shape may be greater than the probability that the object represented by the contour points included in the contour box has the second shape. Therefore, the processor of the object recognition apparatus may preferentially determine whether the contour box satisfying the first reference size range is a first shape.

In the third operation 705, in some implementations, the processor of the object recognition apparatus may identify that at least one contour point exists in each of an area for a reference line segment and an area for a non-reference line segment.

For example, the area for the reference line segment may include an area between a straight line passing through an end point included in the reference line segment and perpendicular to the reference line segment and a straight line passing through a peak point and perpendicular to the reference line segment. The area for the non-reference line segment may include an area between a straight line passing through an end point included in the non-reference line segment and perpendicular to the non-reference line segment and a straight line passing through a peak point and perpendicular to the non-reference line segment.

In a fifth operation 707, in some implementations, the processor of the object recognition apparatus may identify that a first average condition and a first variance condition for the reference line segment, and a second average condition and a second variance condition for the non-reference line segment are satisfied.

For example, the first average condition may include a condition in which a first average value, which is an average value of at least one distance for the reference line segment, is less than a third average threshold and a variance value of the at least one distance for the reference line segment is less than a second variance threshold.

For example, the second average condition may include a condition in which a second average value, which is an average value of at least one distance for the non-reference line segment, is less than a fourth average threshold and a variance value of the at least one distance for the non-reference line segment is less than a fourth variance threshold.

In a sixth operation 709, in some implementations, the processor of the object recognition apparatus may identify whether the length of the reference line segment is less than a reference length. When the length of the reference line segment is greater than or equal to than the reference length the processor of the object recognition apparatus may perform a seventh operation 711. When the length of the reference line segment is less than the reference length (e.g., about 2 m), the processor of the object recognition apparatus may perform the eighth operation 721.

In the eighth operation 721, in some implementations, the processor of the object recognition apparatus may identify that a length condition for a line segment in one direction in a cluster box and a contour box are satisfied. The length condition may include a condition that it is identified that a ratio of a length of a line segment in one direction of the cluster box to a length for a line segment in one direction of the contour box is less than a reference ratio (e.g., about 0.65).

In the ninth operation 723, in some implementations, the processor of the object recognition apparatus may identify that an angle between the reference line segment and the non-reference line segment satisfies a second angle range. This is because a probability that the shape of the distribution of contour points corresponds to a third shape when the angle satisfies the second angle range (e.g., greater than about 80° and less than about) 105° is greater than a probability that the shape of the distribution of contour points corresponds to a third shape when the angle does not satisfy the second angle range.

In a tenth operation 725, in some implementations, the processor of the object recognition apparatus may assign a flag corresponding to the third shape.

In the seventh operation 711, in some implementations, the processor of the object recognition apparatus may identify whether the angle between the reference line segment and the non-reference line segment satisfies a first angle range. When the angle between the reference line segment and the non-reference line segment satisfies the first angle range, in some implementations, the processor of the object recognition apparatus may perform an eleventh operation 713. When the angle between the reference line segment and the non-reference line segment does not satisfy the first angle range, in some implementations, the processor of the object recognition apparatus may perform the twelfth operation 715. This is because the shape of the distribution of contour points is identified as being the L-shape when the angle between the reference line segment and the non-reference line segment satisfies the first angle range (e.g., greater than about 80°, less than about) 120°. It should be noted that, in some implementations, the processor of the object recognition apparatus may identify whether the shape of the distribution of points in a specific layer corresponds to a second shape, even when the angle between the reference line segment and the non-reference line segment does not satisfy the first angle range.

In the twelfth operation 715, in some implementations, the processor of the object recognition apparatus may identify that a third average condition for the reference line segment is satisfied. The third average condition may include a condition that the first average value for the reference line segment is less than or equal to a reference value (e.g., about 0.1).

In the thirteenth operation 717, in some implementations, the processor of the object recognition apparatus may identify that an angle between the reference line segment and the non-reference line segment satisfies a third angle range. When the angle between the reference line segment and the non-reference line segment satisfies the third angle range (e.g., greater than) 160°, the processor of the object recognition apparatus may identify the points included in the specific layer as being distributed in an I-shape.

In a fourteenth operation 719, in some implementations, the processor of the object recognition apparatus may assign a flag corresponding to the second shape.

In the fourth operation 727, in some implementations, the processor of the object recognition apparatus may identify that the size of the contour box satisfies a second reference size range.

In some implementations, among the line segments of the contour box satisfying the second reference size range, the length of a longer line segment among a line segment in the third direction and a line segment in the fourth direction different from the third direction may be greater than a first length value (e.g., about 1 m). The length of a shorter line segment among the line segment in the third direction and the line segment in the fourth direction may be smaller than a fourth length value (e.g., about 1 m). The fourth length value (e.g., about 1 m) in the second reference size range may be greater than the third length value (e.g., about 0.8 m) in a first reference size range.

In a fifteenth operation 729, in some implementations, the processor of the object recognition apparatus may identify that at least one contour point exists in the area for the reference line segment and the length condition of the reference line segment is satisfied. The area for the reference line segment may be the same as the area for the reference line segment in the operation 705. The length condition of reference line segment may include a condition that the reference line segment is greater than a specified length (e.g., about 4.5 m).

In a sixteenth operation 731, in some implementations, the processor of the object recognition apparatus may identify whether a fourth average condition and a third variance condition for the reference line segment are satisfied. When the fourth average condition and the third variance condition for the reference line segment are satisfied, the processor of the object recognition apparatus may perform a seventeenth operation 733. When the fourth average condition or the third variance condition for the reference line segment is not satisfied, the processor of the object recognition apparatus may perform the eighteenth operation 735.

In some implementations, the fourth average condition may include a condition that a first average value for the reference line segment is greater than or equal to a first average threshold. The third variance condition may include a condition that the first variance value is greater than or equal to a first variance threshold.

In the seventeenth operation 733, in some implementations, the processor of the object recognition apparatus may assign a flag corresponding to the second shape.

In the eighteenth operation 735, in some implementations, the processor of the object recognition apparatus may identify that at least one contour point exists in the area for the non-reference line segment.

The area for the non-reference line segment may be the same as the area for the non-reference line segment in the operation 705.

In the nineteenth operation 737, in some implementations, the processor of the object recognition apparatus may identify that a first average condition and a first variance condition for the reference line segment, and a second average condition and a second variance condition for the non-reference line segment are satisfied.

The first average condition may include a condition that a first average value for the reference line segment is greater than or equal to a third average threshold. The first variance condition may include a condition that the first variance value for the reference line segment is greater than or equal to a second variance threshold. The second average condition may include a condition that a second average value for the non-reference line segment is greater than or equal to a fourth average threshold. The second variance condition may include a condition that the second variance value for the non-reference line segment is greater than or equal to a third variance threshold.

In the twentieth operation 739, in some implementations, the processor of the object recognition apparatus may identify that an angle between the reference line segment and the non-reference line segment satisfies a second angle range. This is because the shape of the distribution of contour points is identified as being an L-shape having a short length when the angle of the reference line segment and the non-reference line segment satisfies the second angle range (e.g., greater than about 80°, less than about 105°).

In a 21st operation 741, in some implementations, the processor of the object recognition apparatus may assign a flag corresponding to the third shape.

FIG. 8 shows a flowchart of operation of an object recognition apparatus for assigning a flag to a plurality of layers in an object recognition apparatus or an object recognition method In some implementations of the present disclosure.

Hereinafter, it is assumed that the object recognition apparatus 101 of FIG. 1 performs the process of FIG. 8. Additionally, in the description of FIG. 8, operations described as being performed by the object recognition apparatus 101 or operations described as being performed by the processor 105 may be understood as being controlled by the processor 105 of the object recognition apparatus 101.

Referring to FIG. 8, in a first operation 801, in some implementations, the processor of an object recognition apparatus may determine whether a layer assigned a fourth shape is identified. When the layer assigned the fourth shape is identified, the processor of the object recognition apparatus may perform a second operation 803. When the layer assigned the fourth shape is not identified, the processor of the object recognition apparatus may perform a third operation 805.

In some implementations, the processor of the object recognition apparatus may identify whether a layer assigned the fourth shape exists among a plurality of layers. The fourth shape (e.g., break-shape) may indicate that the distribution of contour points representing an object and included in a specific layer is not identified as one of the first shape, second shape, and third shape. This is because when even one of the plurality of layers is identified as being a layer assigned the fourth shape, it is difficult to identify the object as an object such as a vehicle.

In a second operation 803, in some implementations, the processor of the object recognition apparatus may assign a flag corresponding to the fourth shape. The flag corresponding to the fourth shape may be assigned to a plurality of layers.

In the third operation 805, in some implementations, the processor of the object recognition apparatus may determine whether a layer assigned the first shape is identified. When the layer assigned the first shape is identified, the processor of the object recognition apparatus may perform a fourth operation 807. When the layer assigned the first shape is not identified, the processor of the object recognition apparatus may perform a seventh operation 813.

In some implementations, when among the plurality of layers, a layer assigned a flag corresponding to the fourth shape does not exist, and a layer assigned a flag corresponding to the first shape exists, the processor of the object recognition apparatus may identify a high probability that the distribution of contour points representative of the plurality of layers has the first shape even when there is a layer assigned a flag corresponding to the first shape or a layer assigned a flag corresponding to the second shape exists.

In the fourth operation 807, in some implementations, the processor of the object recognition apparatus may determine whether the number of layers assigned the second shape is greater than the number of layers assigned the first shape. When the number of layers assigned the second shape is greater than the number of layers assigned the first shape, the processor of the object recognition apparatus may perform a fifth operation 809. When the number of layers assigned the second shape is not greater than the number of layers assigned the first shape, the processor of the object recognition apparatus may perform a sixth operation 811.

In some implementations, unlike the existing object recognition apparatus, the processor of the object recognition apparatus may identify the second shape as the shape of the distribution of the contour points representative of the plurality of layers when the number of layers assigned the flag corresponding to the second shape is greater than the number of layers assigned the flag corresponding to the first shape even though a layer assigned the flag corresponding to the first shape exists among the plurality of layers.

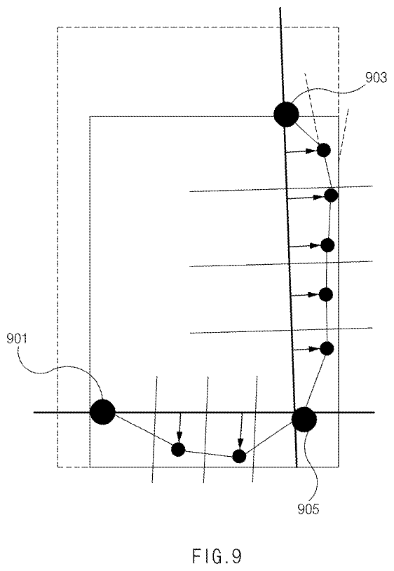

In some implementations, the processor of the object recognition apparatus may assign a flag corresponding to the second shape to a plurality of layers when the reliability value of a layer corresponding to the first shape is less than a first reference reliability (e.g., 75), and the reliability value of a layer corresponding to the second shape is greater than or equal to a second reference reliability (e.g., 70) although the number of layers assigned the first shape is greater than the number of layers assigned the second shape. A method of calculating the reliability of a layer corresponding to the first shape and a method of calculating the reliability of a layer corresponding to the second shape will be described below with reference to FIG. 9.

In the fifth operation 809, in some implementations, the processor of the object recognition apparatus may assign a flag corresponding to the second shape. The flag corresponding to the second shape may be assigned to a plurality of layers.

In the sixth operation 811, in some implementations, the processor of the object recognition apparatus may assign a flag corresponding to the first shape. The flag corresponding to the first shape may be assigned to a plurality of layers.

In the seventh operation 813, in some implementations, the processor of the object recognition apparatus may determine whether a layer assigned the second shape is identified. When the layer assigned the second shape is identified, the processor of the object recognition apparatus may perform an eighth operation 815. When the layer assigned the second shape is not identified, the processor of the object recognition apparatus may perform a ninth operation 817.

In some implementations, the processor of the object recognition apparatus may assign the flag corresponding to the second shape to the plurality of layers although a layer assigned the third shape exists when layers to which the first shape and the fourth shape are assigned do not exist among the plurality of layers and a layer assigned the second shape exists.

In the eighth operation 815, in some implementations, the processor of the object recognition apparatus may assign a flag corresponding to the second shape. The flag corresponding to the second shape may be included in the plurality of layers.

In the ninth operation 817, in some implementations, the processor of the object recognition apparatus may determine whether a layer assigned the third shape is identified. When the layer assigned the third shape is identified, the processor of the object recognition apparatus may perform a tenth operation 819. When the layer assigned the third shape is not identified, the processor of the object recognition apparatus may perform an eleventh operation 821.

In some implementations, the processor of the object recognition apparatus may identify a high probability that the distribution of contour points representative of the plurality of layers is the third shape when no layer assigned a flag corresponding to the first shape, the second shape or the fourth shape exists among a plurality of layers and a flag corresponding to the third shape exists.

In some implementations, when the reliability value of a layer corresponding to the third shape is less than a third reference reliability (e.g., about 60), the processor of the object recognition apparatus may assign a flag corresponding to the fourth shape to the layer although no layer assigned the flag corresponding to the first shape, the second shape, or the fourth shape exists and the flag corresponding to the third shape exists. This is because, in the case of the third shape, a low reliability may affect the identification of the heading direction, which indicates the moving direction of a vehicle.

In the tenth operation 819, in some implementations, the processor of the object recognition apparatus may assign a flag corresponding to the third shape. The flag corresponding to the third shape may be assigned to a plurality of layers.

In the eleventh operation 821, in some implementations, the processor of the object recognition apparatus may assign a flag corresponding to the fourth shape. The flag corresponding to the fourth shape may be assigned to a plurality of layers.

FIG. 9 shows an example of the distribution of contour points for calculating a reliability in an object recognition apparatus or an object recognition method In some implementations of the present disclosure.

Referring to FIG. 9, a first end point 901 and a second end point 903 may correspond to the outermost contour points among contour points representing an object and included in a specific layer. A peak point 905 may include a contour point located furthest from a line segment connecting the first end point 901 and the second end point 903 among the contour points representing an object and included in a specific layer.

In some implementations, the processor of the object recognition apparatus may calculate the reliability of a layer identified as a first shape based on at least one of a first variable value, a second variable value, a third variable value, a fourth variable value, or a fifth variable value, or any combination thereof.

A first line segment may include a line segment connecting the first end point 901 and the peak point 905. A second line segment may include a line segment connecting the second end point 903 and the peak point 905.

In some implementations, the reliability of the layer identified as the first shape may be identified based on the sum of at least one of a value obtained by multiplying the first variable value by a weight, a value obtained by multiplying the second variable value by the weight, a value obtained by multiplying the third variable value by the weight, a value obtained by multiplying the fourth variable value by the weight, or a value obtained by multiplying the fifth variable value by a weight, or any combination thereof.

In some implementations, the first variable value may include a value identified based on the distribution of the contour points representing the object and included in the specific layer. For e example, the processor of the object recognition apparatus may identify the first variable value based on a variance value for distances between the first line segment and contour points near the first line segment, and a variance value for distances between the second line segment and contour points near the second line segment.

For example, when the variance value for the first line segment and/or the variance value for the second line segment are within a first threshold range (e.g., greater than 0 and less than or equal to 0.5), a first line segment value and/or a second line segment value may be identified as being 50, individually. For example, when the variance value for the first line segment and/or the variance value for the second line segment are within a second threshold range (e.g., greater than 0.5 and less than or equal to 1.5), a first line segment value and/or a second line segment value may be identified as being 25. For example, when the variance value for the first line segment and/or the variance value for the second line segment are out of the second threshold range (e.g., greater than about 0.5 and less than or equal to about 1.5), a first line segment value and/or a second line segment value may be identified as being 0.

In some implementations, a first variable value for identifying the reliability of the layer identified as the first shape may be identified based on a value obtained by adding the first line segment value (e.g., about 50) to the second line segment value (e.g., about 50). For example, when the variance value for the first line segment and the variance value for the second line segment are within the first threshold range, a first variable value may be about 100.

In some implementations, the second variable value may be identified based on the distribution of contour points for the first line segment and the distribution of contour points for the second line segment.

For example, when contour points near the first line segment are all identified only in one direction with respect to the first line segment, the first line segment value may be identified as being about 50. For example, when contour points near the second line segment are all identified only in one direction with respect to the second line segment, the second line segment value may be identified as being about 50.

For example, when contour points near the first line segment are all identified in several directions with respect to the first line segment, the first line segment value may be identified as being 0. For example, when contour points near the second line segment are all identified in several directions with respect to the second line segment, the second line segment value may be identified as being 0.

In some implementations, a second variable value for identifying the reliability of the layer identified as the first shape may be identified based on a value obtained by adding the first line segment value (e.g., about 50) to the second line segment value (e.g., about 50). For example, when contour points near the first line segment are all identified only in one direction with respect to the first line segment, and contour points near the second line segment are identified only in one direction with respect to the second line segment, a second variable value may be identified as being about 100.

In some implementations, a third variable value may be identified based on the average of the angles of the contour points. The angle of each contour point may be an angle between a half line connecting a specific contour point to one of contour points on both sides of the specific contour point, and a half line connecting the specific contour point to the other of the contour points on both sides of the specific contour point.

For example, when the average of the angles of the contour points for the first line segment is within a first reference angle range (e.g., greater than 0° and less than or equal to) 10°, the first line segment value may be identified as being about 50. For example, when the average of the angles of the contour points for the second line segment is within the first reference angle range (e.g., greater than 0° and less than or equal to) 10°, the second line segment value may be identified as being about 50.

For example, when the average of the angles of the contour points for the first line segment is within a second reference angle range (e.g., greater than 10° and less than or equal to) 25°, the first line segment value may be identified as being about 25. For example, when the average of the angles of the contour points for the second line segment is within the second reference angle range (e.g., greater than 10° and less than or equal to) 25°, the second line segment value may be identified as being about 25.

In some implementations, a third variable value for identifying the reliability of the layer identified as the first shape may be identified based on a value obtained by adding the first line segment value (e.g., about 50) to the second line segment value (e.g., about 50). For example, when the average of the angles of the contour points for the first line segment is within the second reference angle range (e.g., greater than 10° and less than or equal to) 25° and the average of the angles of the contour points for the second line segment is within the second reference angle range (e.g., greater than 10° and less than or equal to) 25°, a fourth variable value may be identified as being about 75.

In some implementations, the fourth variable value may be identified based on the distribution of contour points for the first line segment and the distribution of contour points for the second line segment.

For example, after dividing the first line segment into a specified number (e.g., dividing the first line segment into four equal parts), when a contour point exists in the area for each divided line segment, the first line segment value may be identified as being about 50.

For example, after dividing the second line segment into a specified number (e.g., dividing the first line segment into four equal parts), when a contour point exists in the area for each divided line segment, the second line segment value may be identified as being about 50.

In some implementations, a fourth variable value for identifying the reliability of the layer identified as the first shape may be identified based on a value obtained by adding the first line segment value (e.g., about 50) to the second line segment value (e.g., about 50).

In some implementations, the fourth variable value for identifying the reliability of the layer identified as the first shape may be identified based on a value obtained by adding the first line segment value (e.g., about 50) to the second line segment value (e.g., about 50). For example, when contour points exist in areas for equally divided line segments with respect to the first line segment, and contour points exist in areas for equally divided line segments with respect to the second line segment, the fourth variable value may be identified as being about 100.

In some implementations, a fifth variable value may be identified based on the ratio of the length in one direction of a contour box identified to include contour points representing an object and included in a specific layer and the length in one direction of a cluster box identified to include contour points included in a plurality of layers.

In some implementations, when the ratio of the length of the contour box in one direction and the length of the cluster box in one direction is greater than a specified value (e.g., about 75%), the fifth variable value may be identified as being about 100.

Although it is described in FIG. 9 to calculate the reliability of the layer identified as the first shape, the reliability of the layer identified as the second shape may also be calculated. However, the reliability of the layer identified as the second shape may be identified based on the first variable value and the third variable value.

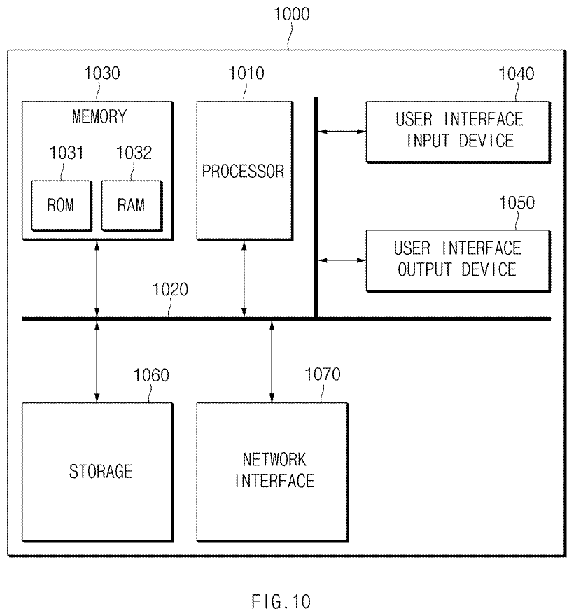

FIG. 10 shows a computing system related to an object recognition apparatus or an object recognition method In some implementations of the present disclosure.

Referring to FIG. 10, a computing system 1000 may include at least one processor 1010, a memory 1030, a user interface input device 1040, a user interface output device 1050, storage 1060, and a network interface 1070, which are connected with each other via a bus 1020.

The processor 1010 may be a central processing unit (CPU) or a semiconductor device that processes instructions stored in the memory 1030 and/or the storage 1060. The memory 1030 and the storage 1060 may include various types of volatile or non-volatile storage media. For example, the memory 1030 may include a ROM (Read Only Memory) 1031 and a RAM (Random Access Memory) 1032.

Thus, the operations of the method or the algorithm described in connection with the implementations disclosed herein may be implemented directly in hardware or a software module executed by the processor 1010, or in a combination thereof. The software module may reside on a storage medium (that is, the memory 1030 and/or the storage 1060) such as a RAM, a flash memory, a ROM, an EPROM, an EEPROM, a register, a hard disk, a removable disk, and a CD-ROM.

The exemplary storage medium may be coupled to the processor 1010, and the processor 1010 may read information out of the storage medium and may record information in the storage medium. Alternatively, the storage medium may be integrated with the processor 1010. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

The present technology may increase accuracy of object recognition by identifying the distribution of contour points obtained through LIDAR in various shapes.

Further, the present technology may increase the identification of a preceding vehicle that is tilted with respect to a host vehicle or a vehicle that cuts in by adding the type of shape that represents the distribution of contour points obtained through LIDAR.

Further, the present technology may increase the ability to identify objects in various situations by lowering the strictness of the determination criteria for specific shapes.

Further, the present technology may increase accuracy of object recognition by adjusting priorities among flags assigned to a plurality of layers.

Further, the present technology may reduce the risk of accidents in autonomous driving by increasing accuracy of object recognition.

Further, the present technology may enhance user experience by increasing the accuracy of object recognition.

In addition, various effects may be provided that are directly or indirectly understood through the disclosure.

What is claimed is:

1. An object recognition apparatus comprising:
a LIDAR sensor configured to obtain contour points of an object;
a memory storing instructions; and
a processor configured to execute the instructions to perform operations comprising:
identifying, whether the object is a dynamic object based on at least one of a reference line segment, a non-reference line segment, or a distribution of the contour points included in a specific layer among a plurality of layers representing the object,
identifying a shape of the distribution of the contour points among a first shape, a second shape and a third shape, and
assigning, based on (i) the object being identified as the dynamic object, (ii) a length of the reference line segment being greater than a reference length, (iii) an angle between the reference line segment and the non-reference line segment being within a specified first angle range, (iv) the angle between the reference line segment and the non-reference line segment not being within the specified first angle range, or (v) the length of the reference line segment being less than or equal to the reference length, a flag corresponding to the identified
shape to the specific layer,
wherein the reference line segment includes a first line segment among (i) a line segment connecting a peak point and a first end point and (ii) a line segment connecting the peak point and a second end point different from the first end point, the first end point and the second end point being two outermost endpoints among the contour points,
wherein the non-reference line segment includes a second line segment among the line segment connecting the first end point and the peak point and the line segment connecting the second end point and the peak point, a length of the second line segment being less than a length of the first line segment, and
wherein the peak point includes a contour point located furthest from a line segment connecting the first end point and the second end point among the contour points.

2. The object recognition apparatus of claim 1, wherein the operations further comprise:
assigning, based on the shape of the distribution of the contour points not being identified as one of the first shape, the second shape, or the third shape, a flag corresponding to a fourth shape to the specific layer,
wherein the fourth shape indicates that the shape of the distribution of the contour points is not being identified as one of the first shape, the second shape, or the third shape.

3. The object recognition apparatus of claim 1, wherein the operations further comprise identifying whether the object is a dynamic object comprises identifying, based on a size of a contour box including the contour points being within a first reference size range, whether the object is a dynamic object based on at least one of the reference line segment, the non-reference line segment, or the distribution of contour points.

4. The object recognition apparatus of claim 2,
wherein identifying whether the object is a dynamic object comprises identifying, based on a size of a contour box including the contour points not being within first reference size range and being within a second reference size range, whether the object is a dynamic object based on at least one of the reference line segment, the distribution of the contour points, or the length of the reference line segment, and
wherein the operations further comprise:
identifying whether a first average value is less than a first average threshold, the first average value being an average value of at least one distance between the reference line segment and part or all of at least one contour point included in an area to which the reference line segment belongs among two areas separated by a straight line halving the angle between the reference line segment and the non-reference line segment and passing through the peak point among the contour points,
identifying whether a first variance value, which is a variance value for the at least one distance, is less than a first variance threshold,
identifying, based on the object being identified as the dynamic object, the first average value being less than the first average threshold, and the first variance value being less than the first variance threshold, that the shape of the distribution of the contour points is the second shape, and assigning a flag corresponding to the second shape to the specific layer,
identifying whether the shape of the distribution of the contour points is the third shape based on the object being identified as the dynamic object and the first variance value being greater than or equal to the first variance threshold or the first average value being greater than or equal to the first average threshold,
based on the shape of the distribution of the contour points being identified as the third shape, assigning a flag corresponding to the third shape to the specific layer, and
assigning, based on the shape of the distribution of the contour points not being identified as one of the first shape, the second shape, or the third shape, the flag corresponding to the fourth shape to the specific layer.

5. The object recognition apparatus of claim 1, wherein the first shape represents a shape including an L-shaped distribution identified through all or part of the contour points,
wherein the second shape represents a shape including an I-shaped distribution identified through all or part of the contour points, and
wherein the third shape represents that the length of a first line segment of the L-shaped distribution identified through all or part of the contour points is shorter than a length of a second line segment of an L-shape corresponding to the first shape.

6. The object recognition apparatus of claim 1, wherein the operations further comprise:
identifying, based on the object being identified as a dynamic object and the length of the reference line segment being less than or equal to the reference length, that a ratio of a length of a line segment of a cluster box identified based on the plurality of layers in one direction and a length of a line segment of a contour box including the contour points in the one direction is less than a reference ratio;
identifying that the angle between the reference line segment and the non-reference line segment satisfies a second angle range; and
identifying that the shape of the distribution of the contour points is the third shape, and assigning, based on the ratio being less than the reference ratio and the angle between the reference line segment and the non-reference line segment being within the second angle range, a flag corresponding to the third shape to the specific layer.

7. The object recognition apparatus of claim 1, wherein the operations further comprise:
identifying, based on the object being identified as the dynamic object, the length of the reference line segment being greater than the reference length, and the angle between the reference line segment and the non-reference line segment does not being within the first angle range, whether a first average value is less than or equal to a second average threshold, the first average value being an average value of at least one distance between the reference line segment and at least one contour point included in an area to which the reference line segment belongs among two areas separated by a straight line halving the angle between the reference line segment and the non-reference line segment and passing through the peak point among the contour points;
identifying whether the angle between the reference line segment and the non-reference line segment is within a third angle range; and
identifying that the shape of the distribution of the contour points is the second shape and assigning, based on the first average value being less than or equal to the second average threshold and the angle between the reference line segment and the non-reference line segment being within the third angle range, a flag corresponding to the second shape to the specific layer.

8. The object recognition apparatus of claim 4, wherein the operations further comprise:
identifying whether at least one contour point (i) exists in an area between a straight line that passes through an end point included in the non-reference line segment and (ii) is perpendicular to the non-reference line segment and a straight line that passes through the peak point and is perpendicular to the non-reference line segment, based on the object being identified as a dynamic object, the first average value being greater than or equal to the first average threshold, or the first variance value being greater than or equal to the first variance threshold;
identifying whether the first average value is less than a third average threshold;
identifying whether the first variance value is less than a second variance threshold;
identifying whether a second average value is less than a fourth average threshold, the second average value being an average value of at least one distance between the non-reference line segment and part or all of at least one contour point included in an area to which the non-reference line segment belongs among two areas separated by a straight line halving the angle between the reference line segment and the non-reference line segment and passing through the peak point among the contour points;
identifying whether a second variance value is less than a third variance threshold, the second variance value being a variance for at least one distance between the non-reference line segment and at least one contour point included in an area to which an end point included in the non-reference line segment belongs;
identifying whether the angle between the reference line segment and the non-reference line segment is within a second angle range; and
identifying that the shape of the distribution of the contour points is the third shape and assigning a flag corresponding to the third shape to the specific layer, based on at least one contour point being identified to exist in the area between the straight line passing through the end point included in the non-reference line segment and perpendicular to the non-reference line segment, and the straight line passing through the peak point and perpendicular to the non-reference line segment, the first average value being less than the third average threshold, the second average value being less than the fourth average threshold, the first variance value being less than the second variance threshold, the second variance value being less than the third variance threshold, and the angle between the reference line segment and the non-reference line segment being within the second angle range.

9. The object recognition apparatus of claim 4, wherein a length of a first line segment, among a line segment in a first direction and a line segment in a second direction different from the first direction, among line segments of the contour box that satisfy the first reference size range, is greater than a first length value and less than a second length value that is greater than the first length value,
wherein a second line segment, among the line segment in the first direction and the line segment in the second direction, is greater than or equal to a third length value,
wherein a length of a third line segment among a line segment in a third direction and a line segment in a fourth direction different from the third direction, among line segments of the contour box that satisfy the second reference size range, is greater than the first length value, and
wherein a fourth line segment, among the line segment in the third direction and the line segment in the fourth direction, is less than a fourth length value greater than the third length value.

10. The object recognition apparatus of claim 2, wherein the operations further comprise:
identifying a layer assigned the flag corresponding to the fourth shape among the plurality of layers;
identifying a layer assigned a flag corresponding to the first shape among the plurality of layers;
identifying whether a number of layers assigned the flag corresponding to the first shape among the plurality of layers is less than a number of layers assigned a flag corresponding to the second shape; and
assigning the flag corresponding to the second shape to the plurality of layers based on the layer assigned the flag corresponding to the fourth shape not being identified, the layer assigned the flag corresponding to the first shape being identified, and the number of layers assigned the flag corresponding to the first shape among the plurality of layers being less than the number of layers assigned the flag corresponding to the second shape.

11. The object recognition apparatus of claim 2, wherein the operations further comprise:
identifying a layer assigned the flag corresponding to the fourth shape among the plurality of layers;
identifying a layer assigned a flag corresponding to the first shape among the plurality of layers;
identifying a layer assigned a flag corresponding to the second shape among the plurality of layers; and
assigning the flag corresponding to the second shape to the plurality of layers based on the layer assigned the flag corresponding to the fourth shape not being identified, the layer assigned the flag corresponding to the first shape not being identified, and the layer assigned the flag corresponding to the second shape being identified.

12. The object recognition apparatus of claim 2, wherein the operations further comprise:
identifying a layer assigned the flag corresponding to the fourth shape among the plurality of layers;
identifying a layer assigned a flag corresponding to the first shape among the plurality of layers;
identifying a layer assigned a flag corresponding to the second shape among the plurality of layers;
identifying a layer assigned a flag corresponding to the third shape among the plurality of layers; and
assigning the flag corresponding to the third shape to the plurality of layers based on the layer assigned the flag corresponding to the fourth shape not being identified, the layer assigned the flag corresponding to the first shape not being identified, the layer assigned the flag corresponding to the second shape not being identified, and the layer assigned the flag corresponding to the third shape being identified.

13. An object recognition method, comprising:
identifying, by a processor, whether an object is a dynamic object based on at least one of a reference line segment, a non-reference line segment, a distribution of contour points included in a specific layer among a plurality of layers representing the object, or the contour points of the object being obtained through a LIDAR sensor, or any combination thereof;
identifying, by the processor, a shape of the distribution of the contour points among a first shape, a second shape and a third shape; and
assigning a flag corresponding to the identified shape to the specific layer based on the object being identified as a dynamic object, a length of the reference line segment being greater than a reference length, an angle between the reference line segment and the non-reference line segment being within a specified first angle range, the angle between the reference line segment and the non-reference line segment not being within the specified first angle range, or the length of the reference line segment being less than or equal to the reference length,
wherein the reference line segment includes a first line segment among a line segment connecting a peak point and a first end point and a line segment connecting the peak point and a second end point different from the first end point, the first end point and the second end point being two outermost endpoints among the contour points,
wherein the non-reference line segment includes a second line segment among the line segment connecting the first end point and the peak point and the line segment connecting the second end point and the peak point, a length of the second line segment being less than a length of the first line segment, and
wherein the peak point includes a contour point located furthest from a line segment connecting the first end point and the second end point among the contour points.

14. The object recognition method of claim 13, further comprising:
assigning, by the processor, a flag corresponding to a fourth shape to the specific layer based on the shape of the distribution of the contour points not being identified as one of the first shape, the second shape, or the third shape,
wherein the fourth shape indicates that the shape of the distribution of the contour points is not identified as one of the first shape, the second shape, or the third shape.

15. The object recognition method of claim 13, wherein identifying, by the processor, whether the object is the dynamic object based on at least one of the reference line segment, the non-reference line segment, or the distribution of the contour points included in the specific layer among the plurality of layers representing the object, includes identifying, based on a size of a contour box including the contour points being within a first reference size range, whether the object is a dynamic object based on at least one of the reference line segment, the non-reference line segment, or the distribution of the contour points, based on a size of a contour box including the contour points being within a first reference size range.

16. The object recognition method of claim 14, further comprising:
identifying, by the processor, based on a size of a contour box including the contour points not being within first reference size range and being within a second reference size range, whether the object is a dynamic object based on at least one of the reference line segment, the distribution of the contour points, or the length of the reference line segment;
identifying, by the processor, whether a first average value is less than a first average threshold, the first average value being an average value of at least one distance between the reference line segment and part or all of at least one contour point included in an area to which the reference line segment belongs among two areas separated by a straight line halving the angle between the reference line segment and the non-reference line segment and passing through the peak point among the contour points;
identifying, by the processor, whether a first variance value, which is a variance value for the at least one distance, is less than a first variance threshold, identifying that the shape of the distribution of the contour points is the second shape based on the object being a dynamic object, the first average value being less than the first average threshold, and the first variance value being less than the first variance threshold, and assigning a flag corresponding to the second shape to the specific layer;
identifying, by the processor, whether the shape of the distribution of the contour points is the third shape based on the object being a dynamic object and the first variance value being greater than or equal to the first variance threshold or the first average value being greater than or equal to the first average threshold, and, based on the shape of the distribution of the contour points being identified as the third shape, assigning a flag corresponding to the third shape to the specific layer; and
assigning, by the processor, the flag corresponding to a fourth shape to the specific layer based on the shape of the distribution of the contour points not being identified as being one of the first shape, the second shape, or the third shape.

17. The object recognition method of claim 13, wherein the first shape represents a shape including an L-shaped distribution identified through all or part of the contour points,
wherein the second shape represents a shape including an I-shaped distribution identified through all or part of the contour points, and
wherein the third shape represents that the length of a long line segment of the L-shaped distribution identified through all or part of the contour points is shorter than a length of a long line segment of an L-shape corresponding to the first shape.

18. The object recognition method of claim 13, wherein the identifying, by the processor, whether the shape of the distribution of the contour points is the third shape based on the object being the dynamic object and the length of the reference line segment being less than or equal to the reference length and, based on the shape of the distribution of the contour points being identified as the third shape, assigning a flag corresponding to the third shape to the specific layer includes:
identifying, by the processor, that a ratio of a length of a line segment of a cluster box identified based on the plurality of layers in one direction and a length of a line segment of a contour box including the contour points in the one direction is less than a reference ratio based on the object being identified as a dynamic object and the length of the reference line segment being less than or equal to the reference length;
identifying that the angle between the reference line segment and the non-reference line segment is within a second angle range; and
identifying that the shape of the distribution of the contour points is the third shape and assigning a flag corresponding to the third shape to the specific layer based on the ratio being less than the reference ratio and the angle between the reference line segment and the non-reference line segment being within the second angle range.

19. The object recognition method of claim 13, wherein identifying, by the processor, whether the shape of the distribution of the contour points is the second shape based on the object being the dynamic object, the length of the reference line segment being greater than the reference length, and the angle between the reference line segment and the non-reference line segment does not being within the first angle range, and, based on the shape of the distribution of the contour points being identified as being the second shape, assigning a flag corresponding to the second shape to the specific layer includes:
identifying, by the processor, whether a first average value is less than or equal to a second average threshold, the first average value being an average value of at least one distance between the reference line segment and at least one contour point included in an area to which the reference line segment belongs among two areas separated by a straight line halving the angle between the reference line segment and the non-reference line segment and passing through the peak point among the contour points;
identifying, by the processor, that the angle between the reference line segment and the non-reference line segment is within a third angle range; and
identifying, by the processor, that the shape of the distribution of the contour points is the third shape and assigning a flag corresponding to the third shape to the specific layer based on the first average value being less than or equal to the second average threshold and the angle between the reference line segment and the non-reference line segment being within the third angle range.

20. The object recognition method of claim 16, wherein identifying, by the processor, whether the shape of the distribution of the contour points is the third shape based on the object being the dynamic object and the first variance value being greater than or equal to the first variance threshold or the first average value being greater than or equal to the first average threshold, and, the shape of the distribution of the contour points being identified as the third shape, assigning a flag corresponding to the third shape to the specific layer includes:
identifying, by the processor, whether at least one contour point (i) exists in an area between a straight line that passes through an end point included in the non-reference line segment and (ii) is perpendicular to the non-reference line segment and a straight line that passes through the peak point and to the non-reference line segment based on the object being a dynamic object, the first average value being greater than or equal to the first average threshold, or the first variance value being greater than or equal to the first variance threshold;
identifying, by the processor, whether the first average value is less than a third average threshold;
identifying, by the processor, whether the first variance value is less than a second variance threshold;
identifying, by the processor, whether a second average value is less than a fourth average threshold, the second average value being an average value of at least one distance between the non-reference line segment and part or all of at least one contour point included in an area to which the non-reference line segment belongs among two areas separated by a straight line halving the angle between the reference line segment and the non-reference line segment and passing through the peak point among the contour points;
identifying, by the processor, whether a second variance value is less than a third variance threshold, the second variance value being a variance for at least one distance between the non-reference line segment and at least one contour point included in an area to which an end point included in the non-reference line segment belongs;
identifying, by the processor, whether the angle between the reference line segment and the non-reference line segment is within a second angle range; and
identifying, by the processor, that the shape of the distribution of the contour points is the third shape and assigning, by the processor, a flag corresponding to the third shape to the specific layer, based on at least one contour point being identified to exist in the area between the straight line passing through the end point included in the non-reference line segment and perpendicular to the non-reference line segment and the straight line passing through the peak point and perpendicular to the non-reference line segment, the first average value being less than the third average threshold, the second average value being less than the fourth average threshold, the first variance value being less than the second variance threshold, the second variance value being less than the third variance threshold, and the angle between the reference line segment and the non-reference line segment being within the second angle range.
